(19) United States
(12) Patent Application Publication
(10) Pub. No.: US 2025/0165719 A1
(43) Pub. Date: May 22, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Satoshi FUKUYAMA, Tokyo (JP); Daisuke AKAZAWA, Tokyo (JP)

(21) Appl. No.: 18/908,006

(22) Filed: Oct. 7, 2024

(30) Foreign Application Priority Data
Nov. 20, 2023 (JP) 2023-196776

(51) Int. Cl. G06F 40/35; G06F 9/54; G06F 16/332

(52) U.S. Cl. CPC G06F 40/35; G06F 16/3329; G06F 9/54

(57) ABSTRACT

An information processing apparatus includes a reception unit that receives input information from a user for a service for a specific purpose in a dialogue format using generative AI that generates output information corresponding to input information. A first acquisition unit inputs information including the input information, to the generative AI, and acquires output information corresponding to the input information, from the generative AI. A second acquisition unit acquires information corresponding to the output information. Based on the information acquired by the second acquisition unit, the information corresponding to the output information, the first generation unit generates answer information corresponding to the input information. Based on the output information acquired by the first acquisition unit, the second generation unit generates, as a history of dialogues with the user, a user dialogue history to be input to the generative AI.

### CROSS REFERENCE TO RELATED APPLICATIONS

This application claims priority based on Japanese patent application No. 2023-196776, filed on Nov. 20, 2023, the entire contents of which are incorporated herein by reference.

The present invention relates to an information processing apparatus, an information processing method, and a non-transitory computer readable storage medium.

### BACKGROUND OF THE INVENTION

### 1. Field of the Invention

Services for exchanging messages with users in a dialogue format have been known conventionally. For example, in a technique proposed in Patent Literature 1, an input message that has been input through speech by a user is received, information including this input message is input to generative AI, such as a language model, and the generative AI is caused to generate a reply message.

### DESCRIPTION OF THE RELATED ART

Patent Literature 1: Japanese Unexamined Patent Application Publication No. 2022-180282

However, the above mentioned technique has a problem that inputting a history of dialogues with the user U, in addition to input messages of the user U, into the generative AI will increase the amount of input information input to the generative AI, although the inputting of the history may be considered for increasing the precision of dialogues with the user U.

### SUMMARY OF THE INVENTION

An information processing apparatus includes a reception unit, a first acquisition unit, a second acquisition unit, a first generation unit, a provision unit, and a second generation unit. The reception unit receives input information from a user for a service for a specific purpose in a dialogue format using generative AI that generates output information corresponding to input information. The first acquisition unit inputs information including the input information received by the reception unit, to the generative AI, and acquires output information corresponding to the input information, from the generative AI. The second acquisition unit acquires information corresponding to the output information acquired by the first acquisition unit. The first generation unit generates answer information corresponding to the input information, on the basis of the information acquired by the second acquisition unit, the information corresponding to the output information. The provision unit provides the answer information generated by the first generation unit, to the user. The second generation unit generates, as a history of dialogues with the user, a user dialogue history to be input to the generative AI, on the basis of the output information acquired by the first acquisition unit.

According to one aspect of an embodiment, an effect of enabling the amount of information to be reduced is achieved, the information being on dialogue histories input to generative AI in a service for exchange of messages with users in a dialogue format.

### BRIEF DESCRIPTION OF THE DRAWINGS

FIG. 1 is a diagram for description of information processing according to an embodiment;

FIG. 2 is a diagram illustrating an example of an information processing system according to the embodiment;

FIG. 3 is a diagram illustrating an example of a configuration of an information processing apparatus according to the embodiment;

FIG. 4 is a diagram illustrating an example of a user information table stored in a user information storage unit of the information processing apparatus according to the embodiment;

FIG. 5 is a diagram illustrating an example of a dialogue data table stored in a dialogue data storage unit of the information processing apparatus according to the embodiment;

FIG. 6 is a diagram for description of an example of processing by a processing unit of the information processing apparatus according to the embodiment;

FIGS. 7A-7D are first diagrams illustrating an example of information arranged in a chat room displayed on a terminal device according to the embodiment;

FIGS. 8A-8D are second diagrams illustrating an example of the information arranged in the chat room displayed on the terminal device according to the embodiment;

FIG. 9 is a diagram illustrating an example of dialogue data generated by a generation unit in the processing unit of the information processing apparatus according to the embodiment;

FIG. 10 is a diagram illustrating an example of location information added as variable information on a user to the dialogue data by the generation unit in the processing unit of the information processing apparatus according to the embodiment;

FIG. 11 is a diagram illustrating an example of the dialogue data updated by the generation unit in the processing unit of the information processing apparatus according to the embodiment;

FIG. 12 is a first diagram illustrating an example of a dialogue history added to the dialogue data by the generation unit in the processing unit of the information processing apparatus according to the embodiment;

FIG. 13 is a second diagram illustrating an example of a reservation history added to the dialogue data by the generation unit in the processing unit of the information processing apparatus according to the embodiment;

FIG. 14 is a diagram illustrating an example of input information that is information input to generative AI by an acquisition unit in the processing unit of the information processing apparatus according to the embodiment;

FIG. 15 is a first diagram illustrating an example of information on a function related to a search included in function information illustrated in FIG. 14;

FIG. 16 is a second diagram illustrating an example of information on a function related to a question included in the function information illustrated in FIG. 14;

FIG. 17 is a third diagram illustrating an example of information on a function related to a reservation included in the function information illustrated in FIG. 14;

FIG. 18 is a diagram illustrating another example of the input information that is the information input to the generative AI by the acquisition unit in the processing unit of the information processing apparatus according to the embodiment;

FIG. 19 is a diagram illustrating yet another example of the input information that is the information input to the generative AI by the acquisition unit in the processing unit of the information processing apparatus according to the embodiment;

FIG. 20 is a diagram illustrating still another example of the input information that is the information input to the generative AI by the acquisition unit in the processing unit of the information processing apparatus according to the embodiment;

FIG. 21 is a flowchart illustrating an example of information processing by the processing unit of the information processing apparatus according to the embodiment;

FIG. 22 is a flowchart illustrating an example of search processing by the processing unit of the information processing apparatus according to the embodiment;

FIG. 23 is a flowchart illustrating an example of question processing by the processing unit of the information processing apparatus according to the embodiment;

FIG. 24 is a flowchart illustrating an example of reservation processing by the processing unit of the information processing apparatus according to the embodiment; and

FIG. 25 is a hardware configuration diagram illustrating an example of a computer that implements functions of the information processing apparatus according to the embodiment.

### DETAILED DESCRIPTION OF THE PREFERRED EMBODIMENTS

Modes (hereinafter, referred to as “embodiments”) for implementing an information processing apparatus, an information processing method, and an information processing program according to the present application will hereinafter be described in detail while reference is made to the drawings. The information processing apparatus, the information processing method, and the information processing program according to the present application are not to be limited by these embodiments. The embodiments may be combined, as appropriate, so long as no contradiction in the processing arises from the combination. In the following embodiments, the same sign will be assigned to parts that are the same and redundant description thereof will be omitted.

### 1. EXAMPLE OF INFORMATION PROCESSING

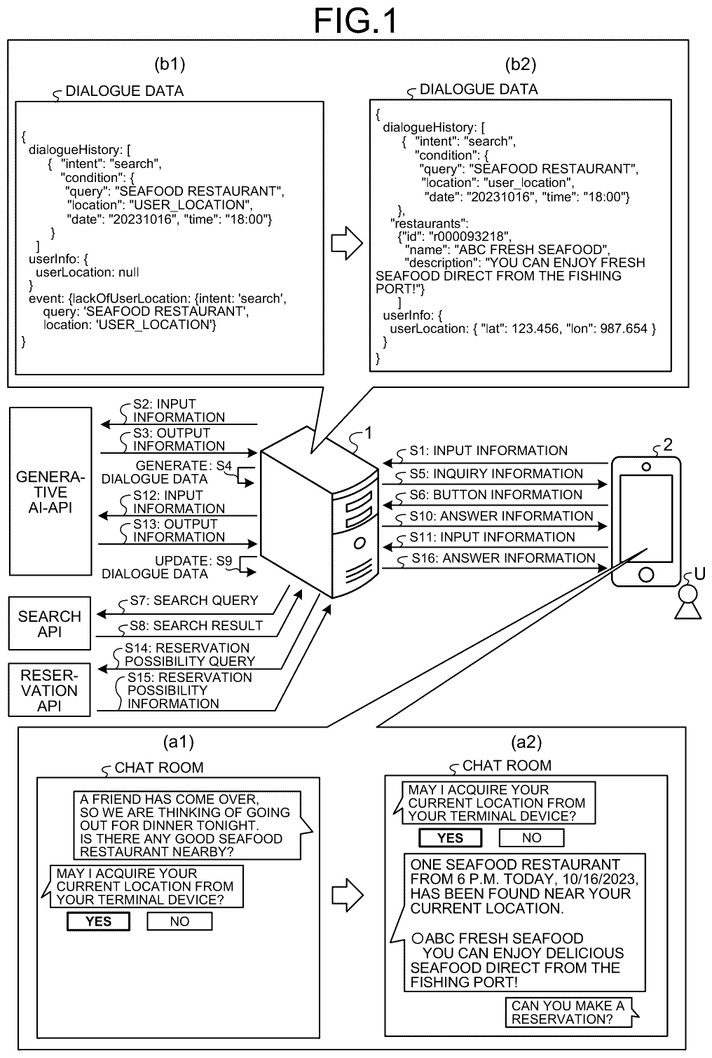

An example of information processing according to an embodiment will be described first by use of FIG. 1. FIG. 1 is a diagram for description of the information processing according to the embodiment.

An information processing apparatus 1 illustrated in FIG. 1 is an information processing apparatus that provides various kinds of information online to a user U, in cooperation with a terminal device 2 of the user U, and is implemented by, for example, one or more servers or a cloud system. The terminal device 2 is, for example, a smartphone or a tablet. In the example illustrated in FIG. 1, although one terminal device 2 is illustrated, the information processing apparatus 1 provides various kinds of services online to users U of plural terminal devices 2 in cooperation with the respective terminal devices 2.

A service provided to the users U by the information processing apparatus 1 is a service provided in a dialogue format to the users U by use of generative artificial intelligence (AI) that outputs answer information corresponding to input information, and is for example, a service for a specific purpose.

The generative AI is, for example text generative AI. Text generative AI is, for example, a large language model that has been trained to infer and output a subsequent token from an input token string, and is, for example, a transfer-based model or a recurrent neural network-based (RNN-based) model.

The transfer-based model is, for example, Generative Pre-trained Transformer (GPT) or Bidirectional Auto-Regressive Dialogues (BARD), but is not limited to these examples. The RNN-based model is, for example, Receptance Weighted Key Value (RWKV), but is not limited to this example.

Input information, such as personal information, is desirably concealed by training performed to prevent the input information from being used in a new answer. The generative AI may be a language model that has been dedicatedly trained (for example, by fine tuning) to generate answer information. The generative AI is arranged in an external information processing apparatus and the information processing apparatus 1 uses the generative AI via an application programming interface (API), but the generative AI may be arranged in the information processing apparatus 1.

The service for a specific purpose, the service being provided in the dialogue format using the generative AI, is, for example, a restaurant reservation service that is a service having restaurant reservation as a specific purpose, but the service for a specific purpose is not limited to this example. For example, the information processing apparatus 1 may provide, instead of or in addition to the service having restaurant reservation as the specific purpose, a service or services having hotel reservation, travel and hotel reservation, movable property transactions, real estate deals, video distribution, newsfeed, and/or employment agency as the specific purpose or purposes.

A terminal device 2 of a user U has a communication application installed thereon, the communication application being an application program for transmitting and receiving messages among users U or to and from the user U. The communication application has, for example, a chat function, a call function, and a wallet function. The communication application may further have any one or more of various functions including a news providing function, a taxi-hailing function, a shopping function, and a gifting function. The communication application is sometimes called a super application, for example.

By using the communication application, the user U is able to use the functions, such as the chat function, the call function, and the wallet function. The chat function is a function that enables exchange of messages in a chat room on a message channel registered as a channel between the user U and another user U or a store S. Being registered as a channel may be referred to as being registered as a friend.

The call function is a function that enables voice calls and video calls between the user U and another user U registered as a channel by the user U. The wallet function has a function for settlement of accounts and remittance, and the user U is able to make payment upon purchase of merchandise or make payment upon use of a service, using the wallet function.

By means of the communication application, the terminal device 2 is able to transmit and receive information to and from the information processing apparatus 1 via the API, but the terminal device 2 may transmit and receive information to and from the information processing apparatus 1 without using the API.

The user U starts the communication application and displays an application screen that is a screen of the communication application, on the terminal device 2, by operating the terminal device 2, and is thereby able to use the functions of the communication application.

The screen of the application includes a registration list screen displaying lists of other users U and services that have been registered as channels, and a chat screen for exchange of chat messages in a chat room with another user U registered as a channel or a chat room for a service registered as a channel. A chat room for a service registered as a channel may hereinafter be simply referred to as a chat room. The communication application may be an application dedicated to the service for a specific purpose.

The information processing apparatus 1 may function as a distribution apparatus that distributes control information to the terminal devices 2. The control information is described in, for example, a script language, such as JavaScript (registered trademark) or a style sheet language, such as Cascading Style Sheets (CSS). The communication application itself distributed from the information processing apparatus 1 may be regarded as the control information.

An example described hereinafter is a case where a user U makes a search request for restaurants and then a reservation request for a restaurant in a restaurant reservation service provided in a dialogue format using generative AI, the restaurant reservation service being the service provided by the information processing apparatus 1 and for a specific purpose, but the embodiment is not limited to this example.

As illustrated in FIG. 1, the information processing apparatus 1 receives input information transmitted from the terminal device 2 (Step S1). The input information is information input in a chat room being displayed on the terminal device 2 by the user U through operation of the terminal device 2 and is information represented by text. The terminal device 2 transmits the information input in the chat room by the user U, to the information processing apparatus 1.

In an example illustrated by (al) in FIG. 1, the input information (an input message) has been input to the terminal device 2 by the user U and the input information is transmitted to the information processing apparatus 1 from the terminal device 2, the input information being information on a character string, ‘A friend has come over, so we are thinking of going out for dinner tonight. Is there any good seafood restaurant nearby?’.

Subsequently, the information processing apparatus 1 inputs information including user input information that is the input information received at Step S1, to the generative AI (Step S2), and acquires output information corresponding to the user input information, from the generative AI (Step S3).

For example, the information processing apparatus 1 inputs information including the user input information and intention definition information for extracting an intention type and an intention from the user input information, to the generative AI, and acquires, as the output information, intention information including information indicating the intention type and information indicating the intention, from the generative AI.

The intention type is a type of an intention of an input sentence represented by the user input information, and in the case where the service for a specific purpose is the restaurant reservation service, the intention type is, for example, restaurant search, restaurant related question, or restaurant reservation, but the intention type is not limited to these examples.

The intention is the intention of the input sentence represented by the user input information, and in the case where the service for a specific purpose is the restaurant reservation service and the intention type is restaurant search, the intention is indicated by information specifying a restaurant type, a restaurant location, a dining date, a dining time, and the number of people dining, for example. The restaurant type is, for example, a genre of food provided by a restaurant, such as, for example, Japanese, Chinese, Italian, French, family restaurants, seafood, or bars, but is not limited to these examples.

Furthermore, the intention is indicated by: information specifying a restaurant (for example, a restaurant identifier (ID)) if the intention type is restaurant-related question; and information specifying a restaurant (for example, a restaurant ID) and information specifying a reservation time and date, a reserved time period, and the number of people to reserve for if the intention type is restaurant reservation.

The intention definition information includes, for example, instruction information including an instruction to extract the intention type and the intention from the user input information, and definition information including information defining the intention type and the intention. The instruction information is, for example, information on a character string, ‘You are a professional operator for a restaurant reservation service. Please determine which one of the following intention types the intention type of an input sentence is and output the intention type determined and the intention. If the intention type of the input sentence is not in the following intention types, please output that there is no intention type.’, but the instruction information is not limited to this example.

The definition information is, for example, a character string, ‘intention type: restaurant search Yn intention: restaurant type, restaurant location, dining date, dining time, number of people dining Yn example of output format: intention type: restaurant search Yn restaurant type: seafood restaurant Yn restaurant location: Akasaka Yn dining date: 2023 Oct. 15 Yn dining time: 18:00 ¥ number of people dining: 2’, but the definition information is not limited to this example.

The information processing apparatus 1 is thereby able to acquire, as the output information, the intention information including the information indicating the intention type and the information indicating the intention, from the generative AI, and is thereby able to appropriately generate answer information corresponding to user input information by using that output information.

Furthermore, the information processing apparatus 1 may use generative AI that has been trained to output intention information as output information in a case where information including user input information and definition information has been input. The definition information is information defining each of plural functions that are able to be executed by the information processing apparatus 1. In this case, the information processing apparatus 1 acquires, as the output information corresponding to the user input information, information specifying a function corresponding to an intention type and information representing arguments of the function corresponding to the intention type, from the generative AI. It will hereinafter be assumed that the information processing apparatus 1 acquires the output information corresponding to the user input information by using the definition information defining each of the plural functions, from the generative AI.

In a case where the service for a specific purpose is a restaurant reservation service, the plural functions include, for example, a function related to a search, a function related to a question, and a function related to a reservation. The function related to a search is a function using a search API provided by a search server that performs restaurant searches, the function related to a question is a function that uses a function using a search API and a function using the generative AI, and the function related to a reservation is a function using a reservation API provided by a reservation server that makes restaurant reservations.

The information processing apparatus 1 may use generative AI that has been trained to output, as the intention information, function specification information including a function used in generation of answer information, the function being one of plural functions, and information representing arguments of that function. In this case, the information processing apparatus 1 inputs the user input information to the generative AI and does not input the definition information to the generative AI.

The arguments of the function related to a search are, for example, pieces of information on a restaurant type, a restaurant location, a dining date, a dining time, and the number of people dining, but are not limited to this example. The arguments of the function related to a question are, for example, pieces of information on a restaurant ID and a search target, but are not limited to this example. The arguments of the function related to a reservation are pieces of information on, for example, a restaurant ID, a reservation time and date, a reserved time period, and the number of people to reserve for, but are not limited to this example.

In a case where information on a character string, ‘A friend has come over, so we are thinking of going out for dinner tonight. Is there any good seafood restaurant nearby?’, has been input as the user input information, together with function information, to the generative AI, function specification information including information specifying a function related to a search is output as the intention information from the generative AI.

In this case, the function specification information includes, as the information on the arguments of the function related to the search, in addition to the information specifying the function related to the search: as information indicating a restaurant type, information on a character string, ‘seafood restaurant’; as information indicating a location of a restaurant, information on a indicating a dining date, information on a character string, ‘2023 Oct. 16’; and as information indicating a dining time, information on a character string, ‘18:00’. The information on these arguments are the information indicating the intention and search condition information that is information indicating search conditions.

On the basis of the output information acquired at Step S3, the information processing apparatus 1 generates dialogue data as information for having a dialogue with the user U (Step S4). The dialogue data are data having, added therein, for example, a history of past dialogues with the user U, variable information on the user U, and information indicating a specific event, and are generated in, for example, units of dialogues with the user U. The units of dialogues are each a unit that has been divided into a time period from a start to an end of a dialogue with the user U.

The variable information on the user U is, for example, information indicating a location of the user U but is not limited to this example. The dialogue data are information having a predetermined format, and are, for example, structured information (structured data) enabling a search or an analysis to be made easily. “The structured information (structured data) is, for example, structured information (structured data) having the Javascript Object Notation (JSON) format, but is not limited to this example.

The information indicating a specific event is, for example, information indicating that an argument included in function specification information is specific information in a case where the argument is the specific information, and the information indicating a specific event includes, for example, information representing an event type and information indicating an event. The information indicating an event type is, for example, information indicating lack of a location of the user U.

The information indicating an event includes, for example, information on a character string, ‘search’, information on a character string, ‘seafood restaurant’, and information on a character string, ‘user location’. The information on the character string, ‘search’, is the information indicating the intention type, and the information on the character string, ‘seafood restaurant’, and the information on the character string, ‘user location’, are the information indicating the intention.

A user dialog history input to the generative AI as a dialogue history of the user U and a generative AI dialogue history input to the generative AI as a dialogue history of the generative AI are added to the history of the dialogues in the dialogue data. The dialogue data generated at Step S4 include, as the user dialogue history, the information indicating the intention type and the information indicating the intention that are included in the intention information acquired from the generative AI at Step S3.

In an example illustrated by (b1) in FIG. 1, the information indicating the intention type is information on a character string, ‘” intent “: “search”’, the information indicating the intention is information on a character string, ‘“query”: “seafood restaurant”’, information on a character string, “USER_LOCATION”, information on a character string, ‘“date”: “20231016”’, and information on a character string, ‘“time”: “18:00”’.

Dialogue data illustrated by (b1) in FIG. 1 include, as the information indicating the event type, information on a character string, ‘lackOfUserLocation’, that is information indicating lack of a location of the user U, and includes, as the information indicating the event, information indicating that a search type is search, the restaurant type is seafood restaurant, and a location is a location of the user U.

The information processing apparatus 1 may add the information indicating the intention type and the information indicating the intention that are included in the intention information acquired from the generative AI at Step S3, to the dialogue data at Step S9 described later, without including them in the dialogue data at Step S4.

The information processing apparatus 1 transmits, to the terminal device 2, inquiry information that is information to inquire of the user U whether or not location information can be transmitted, because search condition information that is information indicating a location of a restaurant is represented by the character string, ‘lackOfUserLocation’ (Step S5). The terminal device 2 displays information in the chat room on the basis of the inquiry information transmitted from the information processing apparatus 1, the information representing an inquiry related to the location of the restaurant.

In the example illustrated by (a1) in FIG. 1, information on a character string, ‘Can I acquire your current location from your terminal device?’, and two buttons for inquiring of the user U whether or not the location information can be transmitted are being displayed in the chat room displayed on the terminal device 2. The two buttons include a first button including information on a character string, ‘Yes’, and a second button including information on a character string, ‘No’.

In a case where the user U has made a selection through a tap on the first button by operating the terminal device 2, the terminal device 2 acquires, by means of a function of the communication application, the location information that is data indicating the current location from a built-in location sensor, and transmits first button selection information including, as the location information on the user U, the location information acquired, to the information processing apparatus 1.

The location information is an example of sensor detection information that the information processing apparatus 1 acquires from the terminal device 2. The sensor detection information that the information processing apparatus 1 acquires from the terminal device 2 is not limited to the location information, and may be, for example, biological information on the user U.

The first button selection information is information indicating that the first button has been selected by the user U, and the first button selection information includes data indicating the current location of the user U by latitude and longitude.

In a case where the user U has operated the terminal device 2 to tap and select the second button, the terminal device 2 transmits second button selection information that is information indicating that the second button has been selected by the user U, to the information processing apparatus 1. Each of the first button selection information and the second button selection information may hereinafter be referred to as button information in a case where the first button selection information and the second button selection information are each referred to without being distinguished from each other.

The information processing apparatus 1 acquires button information transmitted from the terminal device 2 (Step S6). Upon acquisition of the first button selection information, the information processing apparatus 1 generates a search query including, in search condition information, the location information indicated by the first button selection information and the information representing the arguments of the function related to a search specified by the intention information acquired at Step S3, and transmits the search query generated, to the search server through the search API (Step S7).

The location information indicated by the first button selection information is, for example, information indicating the current location of the user U or information indicating an area including the current location of the user U, but is not limited to these examples. The search condition information included in the search query includes, for example, the location information indicated by the first button selection information, and the information representing the arguments of the function related to the search specified by the intention information, the information being information indicating a restaurant type, a dining date, and a dining time, for example.

The information processing apparatus 1 then acquires a search result corresponding to the search query, from the search server through the search API (Step S8). The search result includes, for example, information indicating one or more restaurants that are restaurants of the type indicated by the search condition information, are around the current location of the user U indicated by the search condition information, and are open at the dining time and date indicated by the search condition information.

In the example illustrated in FIG. 1, the search result includes information indicating the number of seafood restaurants that are seafood restaurants open at 6 p.m. on Oct. 16, 2023, and information indicating one or more of these seafood restaurants. In an example illustrated by (a2) in FIG. 1, information on a character string, ‘One seafood restaurant from 6 p.m. today, Oct. 16, 2023, has been found near your current location. ∘ABC Fresh Seafood: You can enjoy delicious seafood direct from the fishing port!’, is being displayed in the chat room displayed on the terminal device 2.

Subsequently, the information processing apparatus 1 updates the dialogue data that are information for having a dialogue with the user U, on the basis of the output information acquired at Step S3, the location information included in the button information acquired at Step S6, and the search result acquired at Step S8 (Step S9).

The dialogue data include, as the user dialogue history, the intention information acquired from the generative AI at Step S3 or information corresponding to this intention information. For example, the user dialogue history includes the information indicating the intention type and the information indicating the intention that are included in the intention information acquired from the generative AI at Step S3.

In dialogue data illustrated by (b2) in FIG. 1, the information indicating the intention type is information on a character string ‘“intent”: “search”’, and the information indicating the intention includes information on a character string, ‘“query”: “seafood restaurant”’ information on a character string, ‘USER_LOCATION’, information on a character string, ‘“date”: “20231016”’ and information on a character string, ‘“time”: “18:00”’.

Furthermore, the dialogue data illustrated by (b2) in FIG. 1 include, as the generative AI dialogue history, the search result acquired from the search server at Step S8 or information corresponding to the search result. In the example illustrated by (b2) in FIG. 1, the generative AI dialogue history includes information on a character string, ‘“name”: “ABC Fresh Seafood “’, and information on a character string, ‘” description “: “You can enjoy delicious dishes prepared using tuna direct from the fishing port!”’. In a case where the search result acquired at Step S8 includes information on plural restaurants, the dialogue data include information indicating the plural restaurants.

Furthermore, the dialogue data include, as the variable information on the user U, the information indicating the current location of the user U, the information being information on a character string, ‘userLocation: {“lat”: 123.456, “lon”: 987.654}’. The information indicating the current location of the user U is information specified by the button information acquired at Step S7, and the information processing apparatus 1 adds, on the basis of the button information acquired at Step S7, the information indicating the current location of the user U to the dialogue data.

Subsequently, on the basis of the search result acquired at Step S8, the information processing apparatus 1 generates answer information, and transmits the answer information (reply message) generated, to the terminal device 2 (Step S10). The terminal device 2 displays the answer information transmitted from the information processing apparatus 1 in the chat room.

For example, it is now supposed that the search result acquired at Step S8 includes information on a character string, ‘“id”: “r000093218”’, information on a character string, ‘“name”: “ABC Fresh Seafood “’, and information on a character string, ‘” description “: “You can enjoy delicious dishes prepared using tuna direct from the fishing port!”’. The information on the character string, ‘“id”: “r000093218”’, is information indicating a restaurant ID.

In this case, for example, the information processing apparatus 1 generates, as the answer information, information on a character string, ‘One seafood restaurant from 6 p.m., Oct. 16, 2023, has been found near your current location. ¥n¥n ⋄ABC Fresh Seafood Yn You can enjoy delicious dishes prepared using tuna direct from the fishing port!’. On the basis of the answer information transmitted from the information processing apparatus 1, the terminal device 2 displays information on a character string, ‘One seafood restaurant near your current location from 6 p.m., Oct. 16, 2023, has been found. @ABC Fresh Seafood You can enjoy delicious dishes prepared using tuna direct from the fishing port!’, in the chat room.

In response to the user U operating the terminal device 2 and inputting text in the chat room, that information is transmitted as input information to the information processing apparatus 1 from the terminal device 2. For example, as illustrated by (a2) in FIG. 1, information representing a character string, ‘Can you make a reservation?’, has been input as the input information by the user U to the terminal device 2 and the input information is transmitted from the terminal device 2 to the information processing apparatus 1.

Subsequently, the information processing apparatus 1 receives the input information (input message) transmitted from the terminal device 2 (Step S11). The information processing apparatus 1 generates information including user input information that is the input information received at Step S11, intention definition information, and a history of dialogues with the user U, and inputs the information generated to the generative AI (Step S12).

The history of dialogues with the user U include a dialogue history of the user U and a dialogue history of the generative AI. At Step S12, the information processing apparatus 1 generates, as the history of dialogues with the user U, a user dialogue history corresponding to the intention information extracted by the generative AI from the dialogue data. For example, on the basis of the dialogue data illustrated by (b2) in FIG. 1, the information processing apparatus 1 generates, as the user dialogue history, information on a character string, ‘Search for a seafood restaurant from 6 p.m. on Oct. 16, 2023.’.

The information processing apparatus 1 is thereby able to appropriately add information indicating a time and date while reducing the number of characters as compared to a case where the user dialogue history is, for example, the information on the character string, ‘A friend has come over, so we are thinking of going out for dinner tonight. Is there any good seafood restaurant nearby?’.

Furthermore, the information processing apparatus 1 generates, as the history of dialogues with the user U, a generative AI dialogue history corresponding to the search result, from the dialogue data. For example, on the basis of the dialogue data illustrated by (b2) in FIG. 1, the information processing apparatus 1 generates, as the generative AI dialogue history, information on a character string, ‘One has been found. Yn Name: ABC Fresh Seafood Yn Restaurant ID: r000093218’.

The generative AI dialogue history does not include information indicating what the restaurant is like, such as information on a character string, ‘You can enjoy delicious dishes prepared using tuna direct from the fishing port!’. The information processing apparatus 1 thereby enables unnecessary information to be deleted appropriately while reducing the number of characters in the generative AI dialogue history.

Subsequently, the information processing apparatus 1 acquires output information corresponding to the user input information input to the generative AI at Step S12, from the generative AI (Step S13). For example, at Step S12, the information processing apparatus 1 inputs a history of dialogues with the user U, user input information, and intention definition information, to the generative AI, and at Step S13, the information processing apparatus 1 acquires, as output information, intention information including information indicating an intention type and information indicating an intention, from the generative AI.

For example, the information indicating an intention type is information representing a function related to a reservation, and the information indicating an intention is information indicating reservation conditions. The information indicating the intention includes, as information on arguments of the function related to the reservation, for example: as a restaurant ID, information on a character string, ‘“id”: “r000093218”’; as information on a dining date, information on a character string, ‘2023 Oct. 16’; as information on a dining time, information on a character string, ‘18:00’; and as information on the number of people dining, information on a character string, ‘2’.

The information on these arguments is reservation condition information that is information indicating reservation conditions. In a case where the function specification information does not include any information indicating the number of people dining, the information processing apparatus 1 inquires of the user U the number of people dining and acquires information indicating the number of people dining, from the terminal device 2.

Subsequently, on the basis of the output information acquired at Step S13, the information processing apparatus 1 generates a reservation possibility query including information indicating reservation check conditions, and transmits the reservation possibility query generated, to the reservation server through the reservation API (Step S14). The reservation possibility query includes, for example: as a restaurant ID, information on a character string, ‘“id”: “r000093218”’; as information on a dining date, information on a character string, ‘2023 Oct. 16’; as information on a dining time, information on a character string, ‘18:00’; and as information on the number of people dining, information on a character string, ‘2’.

Subsequently, the information processing apparatus 1 acquires reservation possibility information corresponding to the reservation possibility query, from the reservation server through the reservation API (Step S15). The reservation possibility information is, for example, information indicating whether or not a reservation at a restaurant specified by the reservation possibility query is possible under conditions specified by the reservation possibility query.

Subsequently, on the basis of the reservation possibility information acquired at Step S15, the information processing apparatus 1 transmits, as answer information (reply message), information indicating whether or not a reservation at a restaurant, for which the user U has inquired about possibility of a reservation with the user input information from Step S11, is possible, to the terminal device 2 (Step S16).

As described above, the information processing apparatus 1 causes the terminal device 2 of the user U to display buttons for acquiring sensor detection information from the terminal device 2 for the service in the dialogue format using the generative AI that outputs answer information corresponding to input information, and receives a selection of a button by the user U. In a case where the information processing apparatus 1 has received a selection of a button, the information processing apparatus 1 acquires the sensor detection information, and generates information that is information corresponding to the sensor detection information and included in the input information input to the generative AI. The information processing apparatus 1 is thereby able to appropriately acquire information on the user U in the service for exchanging messages in the dialogue format with the user U.

Furthermore, the information processing apparatus 1 receives, from the user U, input information for the service for a specific purpose in a dialogue format using the generative AI that generates output information corresponding to input information, the information processing apparatus 1 inputs information including the input information, to the generative AI, and the information processing apparatus 1 acquires output information corresponding to the input information, from the generative AI. The information processing apparatus 1 then acquires information corresponding to the output information, from the generative AI, and generates answer information corresponding to the input information on the basis of the information corresponding to the output information, and generates, as a history of dialogues with the user U, a user dialogue history to be input to the generative AI, on the basis of the output information. The information processing apparatus 1 thereby enables reduction in the amount of information in the history of dialogues to be input to the generative AI in the service for exchanging messages in the dialogue format with the user U.

### 2. CONFIGURATION OF INFORMATION PROCESSING SYSTEM

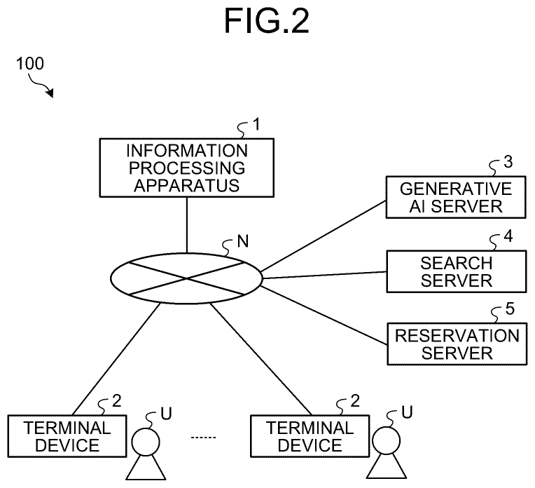

FIG. 2 is a diagram illustrating an example of a configuration of an information processing system according to the embodiment. As illustrated in FIG. 2, an information processing system 100 according to the embodiment includes the information processing apparatus 1, a plurality of the terminal devices 2, a generative AI server 3, a search server 4, and a reservation server 5.

The terminal devices 2 are used by users U who are different from one another. The terminal devices 2 are any of, for example, notebook personal computers (PC), desktop PCs, smartphones, tablet PCs, and wearable devices. A wearable device is, for example, smart glasses or a smart watch, but is not limited to these examples.

The generative AI server 3 is an information processing apparatus that: inputs input information acquired from the information processing apparatus 1, to the generative AI through a generative AI-API, which is an API dedicated to the generative AI server 3; and provides output information output from the generative AI, to the information processing apparatus 1 through the generative AI-API. The generative AI may be arranged in the information processing apparatus 1.

The search server 4 is an information processing apparatus that: makes a search, through a search API, which is an API dedicated to the search server 4, for information corresponding to a search query acquired from the information processing apparatus 1; and provides a result of the search to the information processing apparatus 1 through the search API. The information processing apparatus 1 may have functions of the search server 4.

The reservation server 5 is an information processing apparatus that: performs, through a reservation API, which is an API dedicated to the reservation server 5, processing corresponding to a query acquired from the information processing apparatus 1; and that provides a result of the processing to the information processing apparatus 1 through the reservation API. The information processing apparatus 1 may have functions of the reservation server 5.

The information processing apparatus 1, the terminal devices 2, the generative AI server 3, the search server 4, and the reservation server 5 are communicably connected to one another by wire or wirelessly via a network N. The information processing system 100 illustrated in FIG. 2 may include any of: a plurality of the information processing apparatuses 1; a plurality of the generative AI servers 3; a plurality of the search servers 4; and a plurality of the reservation servers 5.

Examples of the network N include a wide area network (WAN), such as the Internet, and mobile telecommunications networks, such as Long Term Evolution (LTE), 4th Generation (4G), and 5th Generation (5th Generation Mobile Communication System: 5G).

The terminal devices 2 are connected to the network N via short-range wireless communication, such as Bluetooth (registered trademark) or a wireless local area network (LAN), and are capable of communicating with the information processing apparatus 1, the generative AI server 3, the search server 4, and the reservation server 5, for example.

### 3. CONFIGURATION OF INFORMATION PROCESSING APPARATUS 1

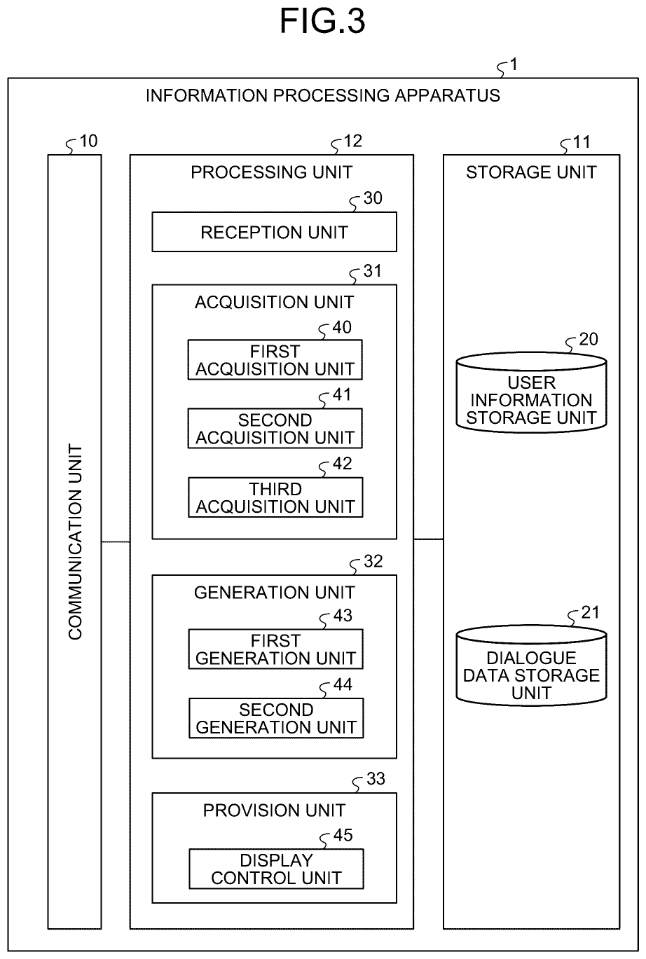

FIG. 3 is a diagram illustrating an example of a configuration of the information processing apparatus 1 according to the embodiment. As illustrated in FIG. 3, the information processing apparatus 1 has a communication unit 10, a storage unit 11, and a processing unit 12.

### 3.1. Communication Unit 10

The communication unit 10 is implemented by, for example, a communication module or a network interface card (NIC). The communication unit 10 is connected to the network N by wire or wirelessly, and transmits and receives information to and from various other devices. For example, the communication unit 10 transmits and receives information to and from the terminal devices 2 via the network N.

### 3.2. Storage Unit 11

The storage unit 11 is implemented by, for example: a semiconductor memory element, such as a random access memory (RAM) or a flash memory; or a storage device, such as a hard disk or an optical disk. The storage unit 11 has a user information storage unit 20 and a dialogue data storage unit 21.

### 3.2.1. User Information Storage Unit 20

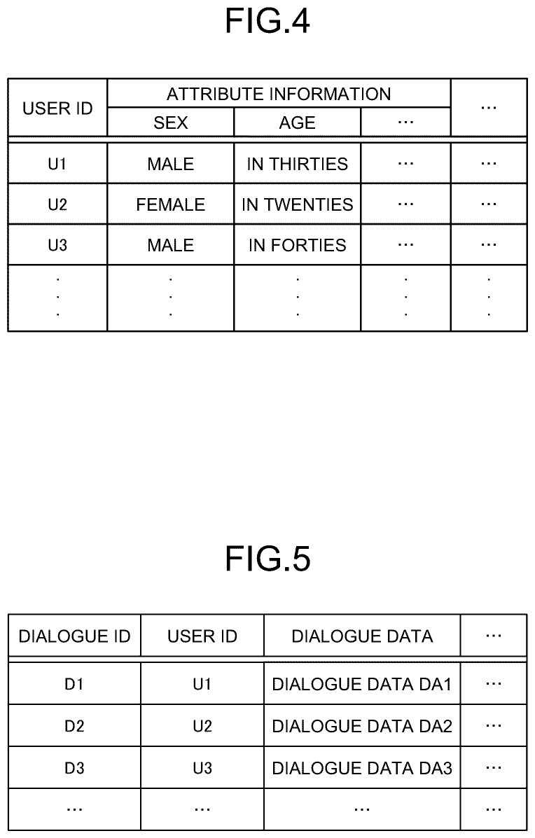

The user information storage unit 20 stores various kinds of information related to the users U. FIG. 4 is a diagram illustrating an example of a user information table stored in the user information storage unit 20 of the information processing apparatus 1 according to the embodiment.

As illustrated in FIG. 4, the user information table stored in the user information storage unit 20 includes items, such as “user ID” and “attribute information”. “User ID” is identification information identifying the users U.

“Attribute information” is information related to user attributes of the users U corresponding to “user ID” and includes information on psychographic attributes and information on demographic attributes. The demographic attributes are, for example, sexes, ages, places of residence, and occupations, and the psychographic attributes are, for example: interests, such as travel, clothing, cars, and religions; lifestyles; thought; and tendencies of thought.

### 3.2.2. Dialogue Data Storage Unit 21

The dialogue data storage unit 21 stores various kinds of information related to dialogue data. FIG. 5 is a diagram illustrating an example of a dialogue data table stored in the dialogue data storage unit 21 of the information processing apparatus 1 according to the embodiment.

As illustrated in FIG. 5, the dialogue data table stored in the dialogue data storage unit 21 includes items, such as “dialogue ID”, “user ID”, and “dialogue data”. “Dialogue ID” is dentification information identifying the dialogue data.

“User ID” is user IDs of the users U associated with the dialogue data corresponding to “dialogue ID”. “Dialogue data” are the dialogue data corresponding to “dialog ID” and include histories of dialogues with the users U associated with “user ID”. The histories of the dialogues with the users U include, for example, dialogue histories of the users U and dialogue histories of the generative AI.

The dialogue histories of the users U are information generated as dialogue information on the users U on the basis of output information that is information extracted by the generative AI from user input information that is input information from the users U, and are information input as part of the input information to the generative AI, the part being the histories of the dialogues with the users U.

The dialogue histories of the generative AI are information generated as dialogue information on the generative AI on the basis of information (for example, a search result from the search server 4 or reservation possibility information from the reservation server 5) acquired on the basis of the output information output from the generative AI according to the user input information, and are information input as part of the input information to the generative AI, the part being the histories of dialogues with the users U.

### 3.3. Processing Unit 12

The processing unit 12 is a controller and is implemented by various programs (corresponding to an example of an information processing program) being executed by, for example, a processor, such as a central processing unit (CPU) or a microprocessing unit (MPU), with a RAM serving as a work area, the various programs having been stored in a storage device inside the information processing apparatus 1.

Furthermore, the processing unit 12 may be a controller, and may be implemented by, for example, an integrated circuit, such as an application specific integrated circuit (ASIC), a field programmable gate array (FPGA), or a general purpose graphic processing unit (GPGPU).

As illustrated in FIG. 3, the processing unit 12 has a reception unit 30, an acquisition unit 31, a generation unit 32, and a provision unit 33, and implements or executes functions and effects of information processing described hereinafter. An internal configuration of the processing unit 12 is not limited to the configuration illustrated in FIG. 3, and may be any other configuration that executes the later described information processing.

### 3.3.1. Reception Unit 30

By receiving various kinds of information transmitted from the terminal devices 2 of the users U, the reception unit 30 receives various kinds of operation, such as input of information and selection of buttons by the users U. For example, the reception unit 30 receives user input information that is input information on a user U for a service for a specific purpose in a dialogue format using generative AI that generates output information corresponding to input information.

The service for a specific purpose is a restaurant reservation service that is a service having restaurant reservation as its specific purpose, but the service is not limited to this example. For example, the service for a specific purpose may be, instead of or in addition to the restaurant reservation service, a service or services having hotel reservation, travel and hotel reservation, movable property transactions, real estate deals, video distribution, newsfeed, and/or employment agency as the specific purpose or purposes.

The reception unit 30 receives as input information from a user U in a chat room, for example, information on a character string in a natural language that has been input as a dialogue of the user U in the chat room being displayed on a terminal device 2 through operation of the terminal device 2 by the user U.

In a case where a user U has operated a terminal device 2 and input a character string in a natural language as a dialogue of the user U in a chat room being displayed on the terminal device 2, the terminal device 2 transmits, as input information from the user U in the chat room, information on that character string, to the information processing apparatus 1.

Furthermore, by receiving button information transmitted from a terminal device 2, the reception unit 30 receives a selection of a button by a user U. For example, by receiving first button selection information transmitted from a terminal device 2, the reception unit 30 receives a selection of a first button by a user U, and by receiving second button selection information transmitted from a terminal device 2, the reception unit 30 receives a selection of a second button by a user U.

Furthermore, by receiving a third button selection information transmitted from a terminal device 2, the reception unit 30 receives a selection of a third button by a user U, and by receiving fourth button selection information transmitted from a terminal device 2, the reception unit 30 receives a selection of a fourth button by a user U.

### 3.3.2. Acquisition Unit 31

The acquisition unit 31 acquires various kinds of information. The acquisition unit 31 acquires sensor detection information transmitted from a terminal device 2. The sensor detection information is information detected by a built-in sensor in the terminal device 2. Examples of the built-in sensor in the terminal device 2 include a location sensor, a gyro sensor, an acceleration sensor, a geomagnetic sensor, an illuminance sensor, a temperature sensor, a barometric pressure sensor, and a biological sensor.

The location sensor detects, for example, a location of the terminal device 2, the location being the current location of a user U. The location sensor receives plural position measurement signals transmitted from plural positioning satellites in a global navigation satellite system (GNSS) and detects the current location of the user U on the basis of the plural position measurement signals received.

The biological sensor is, for example, a sensor to detect heartbeat of a posting user, a sensor to detect pulses of the posting user, a sensor to detect blood pressure of the posting user, a sensor to detect pupillary reaction of the posting user, a sensor to detect brain waves of the posting user, and/or a sensor to detect blood oxygen concentration of the posting user. The sensor detection information may be information detected by a terminal device other than the terminal device 2 and acquired by the terminal device 2.

Furthermore, the acquisition unit 31 acquires various kinds of information from, for example, the terminal devices 2, the generative AI of the generative AI server 3, the search server 4, the reservation server 5, and the storage unit 11. The acquisition unit 31 acquires user input information received by the reception unit 30, for example.

In a case where a selection of the first button has been received by the reception unit 30, for example, the acquisition unit 31 acquires sensor detection information from the terminal devices 2. The sensor detection information acquired by the acquisition unit 31 is, for example, location information on the user U, environment information indicating brightness, temperature, and pressure around the user U, or biological information on the user U.

Furthermore, the acquisition unit 31 inputs information including input information from a user U, to the generative AI, and acquires output information corresponding to the input information, from the generative AI. For example, the acquisition unit 31 inputs input information to the generative AI through the generative AI-API and acquires output information corresponding to the input information from the generative AI through the generative AI-API.

The generative AI is, for example, text generative AI. The text generative AI is, for example, a language model that has been trained to infer and output a subsequent token from a token string that is input, and is, for example, a transfer-based model or an RNN-based model.

The transfer-based model is, for example, GPT or BARD, but is not limited to these examples. The RNN-based model is, for example, RWKV, but is not limited to this example. Information that has been input desirably has information concealed by training so that the information is not used in a new answer, the information being, for example, personal information that has been input. Furthermore, the generative AI may be a language model that has been dedicatedly trained (for example, subjected to fine tuning) for generating answer information. The generative AI is arranged in an external information processing apparatus and the acquisition unit 31 uses the generative AI via the API, but the generative AI may be arranged in the information processing apparatus 1.

Furthermore, the acquisition unit 31 transmits a search query to the search server 4 and acquires a search result corresponding to the search query from the search server 4. For example, the acquisition unit 31 transmits a search query to the search server 4 through the search API and acquires a search result corresponding to the search query, from the search server 4 through the search API.

Furthermore, the acquisition unit 31 transmits a query, such as a reservation possibility query or a reservation query, to the reservation server 5, and acquires a processing result corresponding to the query, from the reservation server 5. For example, the acquisition unit 31 transmits a search query to the reservation server 5 through the reservation API and acquires a processing result corresponding to the query, from the reservation server 5 through the reservation API.

The acquisition unit 31 has a first acquisition unit 40, a second acquisition unit 41, and a third acquisition unit 42, each of which will hereinafter be described specifically.

### 3.3.2.1. First Acquisition Unit 40

The first acquisition unit 40 acquires user input information that is input information from a user U received by the reception unit 30, inputs information including the user input information to the generative AI, and acquires output information corresponding to the user input information from the generative AI.

For example, the first acquisition unit 40 inputs information including user input information and intention definition information for extraction of an intention type and an intention from the user input information, to the generative AI, and acquires, as output information, intention information including information indicating the intention type and information indicating the intention, from the generative AI.

The intention type is, for example, a type of an intention of an input sentence represented by the user input information, and in a case where the service for a specific purpose is a restaurant reservation service, for example, the intention type is restaurant search, restaurant-related question, or restaurant reservation, but the intention type is not limited to these examples.

The intention is the intention of the input sentence represented by the user input information, and in a case where the service for a specific purpose is a restaurant reservation service, the intention is indicated by information specifying a restaurant type, a restaurant location, a dining date, a dining time, and the number of people dining, if the intention type is restaurant search. The restaurant type is, for example, a genre of food provided by a restaurant, such as, for example, Japanese, Chinese, Italian, French, family restaurants, seafood, or bars, but is not limited to these examples.

Furthermore, the intention is indicated by information (for example, a restaurant ID) specifying a restaurant if the intention type is restaurant-related question, and is indicated by information (for example, a restaurant ID) specifying a restaurant and information specifying a reservation time and date, a reserved time period, and the number of people to reserve for if the intention type is restaurant reservation.

The intention definition information includes, for example, instruction information including an instruction to extract, from the user input information, the intention type and the intention, and definition information including information defining the intention type and the intention. The instruction information is, for example, information on a character string, ‘You are a professional operator for a restaurant reservation service. Please determine which one of the following intention types the intention type of an input sentence is and output the intention type determined and the intention. If the intention type of the input sentence is not in the following intention types, please output that there is no intention type.’, but the instruction information is not limited to this example.

If, for example, the intention type is restaurant search, the definition information is a character string, ‘Intention type: restaurant search Yn Intention: restaurant type, restaurant location, dining date, dining time, number of people dining Yn Example of output format: Intention type: restaurant search Yn Restaurant type: seafood restaurant Yn Restaurant location: Akasaka ¥n Dining date: 2023 Oct. 15 ¥n Dining time: 18:00 ¥ Number of people dining: 2’, but the definition information is not limited to this example.

The first acquisition unit 40 is thereby able to acquire, as the output information, the intention information including the information indicating the intention type and the information indicating the intention, from the generative AI, and is thereby able to appropriately generate answer information corresponding to user input information by using the output information.

Furthermore, the first acquisition unit 40 may use generative AI that has been trained to output, as output information, intention information, in a case where information including input user information and definition information has been input. The definition information is information defining each of plural functions that are able to be executed by the processing unit 12 of the information processing apparatus 1. In this case, the first acquisition unit 40 acquires, as output information corresponding to user input information, information specifying a function corresponding to an intention type and information representing arguments of the function corresponding to the intention type, from the generative AI.

As described above, by inputting information including, as intention definition information, definition defining each of plural functions, to the generative AI, the first acquisition unit 40 is able to acquire, as intention information, function specification information, from the generative AI, the function specification information being information including: information specifying a function (a function corresponding to an intention type) used in generation of answer information, the function being one of the plural functions; and information representing arguments of the function.

In a case where the service for a specific purpose is a restaurant reservation service, the plural functions include, for example, a function related to a search, a function related to a question, and a function related to a reservation. The function related to a search is a function using the search API provided by the search server 4 that performs restaurant searches, the function related to a question is a function that uses a function using the search API and a function using the generative AI, and the function related to a reservation is a function using the reservation API provided by the reservation server 5 that makes restaurant reservations.

The first acquisition unit 40 may use generative AI that has been trained to output, as intention information, function specification information including information indicating a function used in generation of answer information and arguments of the function, the function being one of the plural functions. In this case, the first acquisition unit 40 inputs user input information to the generative AI and does not input definition information to the generative AI.

The arguments of the function related to a search are, for example, information on a restaurant type, a restaurant location, a dining date, a dining time, and the number of people dining, but the arguments are not limited to this example. The arguments of the function related to a question are, for example, information on a restaurant ID and a search target, but the arguments are not limited to this example. The arguments of the function related to a reservation are, for example, information on a restaurant ID, a reservation time and date, a reserved time period, and the number of people to reserve for, but the arguments are not limited to this example.

In a case where information on a character string, ‘A friend has come over, so we are thinking of going out for dinner tonight. Is there any good seafood restaurant nearby?’, has been input as user input information, together with function information, to the generative AI, function specification information including information specifying a function related to a search is output as intention information from the generative AI.

In this case, in addition to the information specifying the function related to the search, the function specification information includes, as information on arguments of the function related to the search: as information indicating a restaurant type, information on a character string, ‘seafood restaurant’; as information indicating a restaurant location, information on a indicating a dining date, information on a character string, ‘2023 Oct. 16’; and as information indicating a dining time, information on a character string, ‘18:00’.

The information on these arguments is information indicating the intention and is search condition information that is information indicating search conditions.

In a case where a function corresponding to the user input information is unable to be specified, the generative AI does not output, as output information, function specification information. In this case, the first acquisition unit 40 is unable to acquire function specification information from the generative AI.

In addition to input information received by the reception unit 30, the first acquisition unit 40 inputs information including a dialogue history included in dialogue data, to the generative AI, and acquires output information corresponding to the input information, from the generative AI.

The dialogue history included in the dialogue data include a user dialogue history that is a dialogue history of the user U and a generative AI dialogue history that is a dialogue history of the generative AI. The user dialogue history may be part of the user input information, the part having been extracted from the user input information, without being the user input information itself, and the generative AI dialogue history may be part of the answer information for the user U, the part having been extracted from the answer information, without being the answer information itself.

Therefore, the first acquisition unit 40 enables reduction in the amount of information (for example, the number of tokens) on a dialogue history input to the generative AI in a service for exchange of messages with a user U in a dialogue format.

In a case where input information from a user U is a character string, ‘A friend has come over, so we are thinking of going out for dinner tonight. Is there any good seafood restaurant nearby?’, for example, dialogue data include, as a user dialogue history, information on a character string, ‘Search for a seafood restaurant from 6 p.m. on Oct. 16, 2023.’. The first acquisition unit 40 is thereby able to appropriately add information indicating the time and date while reducing the number of characters, as compared to a case where the input information from the user U is treated as the user dialogue history.

Furthermore, in a case where answer information to a user U is information on a character string, ‘One has been found. ¥n Name: ABC Fresh Seafood ¥n You can enjoy delicious dishes prepared using tuna direct from the fishing port!’, the generative AI dialogue history is information on a character string, ‘One has been found. Yn Name: ABC Fresh Seafood ¥n Restaurant ID: r000093218’, and does not include information indicating what the restaurant is like, such as information on a character string, ‘You can enjoy delicious dishes prepared using tuna direct from the fishing port!’. The first acquisition unit 40 thereby enables reduction in the number of characters in the generative AI dialogue history and appropriate deletion of unnecessary information.

Furthermore, by extracting part of a dialogue history included in dialogue data and inputting information including the extracted information and input information received by the reception unit 30 to the generative AI, the first acquisition unit 40 is able to acquire output information corresponding to the input information from the generative AI.

For example, in a case where dialogue data include plural pieces of search information, the first acquisition unit 40 extracts a new piece of search information from the plural pieces of search information, inputs information including the new piece of search information to the generative AI, and acquires output information corresponding to the new piece of information input, from the generative AI.

Furthermore, in a case where dialogue data include plural pieces of search information and question information corresponding to the latest piece of search information also, the first acquisition unit 40 extracts a new piece of search information from the plural pieces of search information, inputs information including that new piece of search information to the generative AI, and acquires output information corresponding to the new piece of search information input, from the generative AI.

### 3.3.2.2. Second Acquisition Unit 41

The second acquisition unit 41 acquires information corresponding to output information acquired by the first acquisition unit 40. For example, the second acquisition unit 41 acquires, as the information corresponding to the output information, information corresponding to intention information including information indicating an intention type and information indicating an intention that have been acquired by the first acquisition unit 40.

The second acquisition unit 41 determines, on the basis of the information indicating the intention type acquired by the first acquisition unit 40, an access target, and acquires, as the information corresponding to the output information, information corresponding to the information indicating the intention, from the access target determined. The access target is, for example, one or more of plural servers including the generative AI server 4, the search server 4, and the reservation server 5. The access target is not limited to servers, and may be, for example, the storage unit 11 and/or another information processing apparatus.

If the information indicating the intention type is information indicating a search, for example, the second acquisition unit 41 generates a search query on the basis of the information indicating the intention acquired by the first acquisition unit 40. The second acquisition unit 41 then transmits the search query generated, to the search server 4 through the search API, and acquires, as the information corresponding to the output information, a search result corresponding to the search query, from the search server 4 through the search API.

In a case where sensor detection information has been acquired by the third acquisition unit 42, the second acquisition unit 41 transmits a search query including, as information on a search condition, the sensor detection information, to the search server 4, and acquires information corresponding the output information from a search server 4. In a case where the sensor detection information is location information on the user U, the second acquisition unit 41 transmits a search query including, as the information on a search condition, the current location of the user U, to the search server 4, and in a case where the sensor detection information is biological information, the second acquisition unit 41 transmits a search query including, as the information on a search condition, the biological information on the user U, to the search server 4.

Furthermore, if the information indicating the intention type is information indicating a question, for example, the second acquisition unit 41 acquires, on the basis of the information indicating the intention, necessary information from the search server 4 through the search API. In a case where the intention information does not include the information indicating the intention, the second acquisition unit 41 may acquire detailed information on a restaurant from the search server 4 through the search API.

In the case where sensor detection information has been acquired by the third acquisition unit 42, the second acquisition unit 41 may transmit a search query including, as the information on a search condition, the sensor detection information, to the search server 4, and acquire necessary information from the search server 4.

In a case where information has been acquired from the search server 4, the second acquisition unit 41 inputs information including the information acquired from the search server 4 and user input information received by the reception unit 30, to the generative AI, and acquires information corresponding to output information from the generative AI.

Furthermore, if the information indicating the intention type is information indicating a reservation, for example, the second acquisition unit 41 generates a query on the basis of the information indicating the intention acquired by the first acquisition unit 40. The second acquisition unit 41 then transmits the query generated, to the reservation server 5 through the reservation API, and acquires, as information corresponding to output information, a processing result corresponding to the query from the reservation server 5 through the reservation API.

### 3.3.2.3. Third Acquisition Unit 42

In a case where a selection of a first button has been received by the reception unit 30, the third acquisition unit 42 acquires sensor detection information.

For example, in the case where the selection of the first button has been received by the reception unit 30, the third acquisition unit 42 acquires location information as the sensor detection information. The third acquisition unit 42 acquires the sensor detection information included in first button selection information received by the reception unit 30. The first button is a button including information representing a character string, ‘search by current location’, but without being limited to this example, for example, the first button may be a button including information representing a character string, ‘permit transmission of sensor information from terminal device and search by current location’.

Furthermore, in the case where the selection of the first button has been received, the third acquisition unit 42 may acquire, as the sensor detection information, in addition to or instead of the location information, biological information on the user U, for example. In this case, the first button includes, instead of the information representing the character string, ‘search by current location’, information representing a character string, ‘permit transmission of sensor information and search using sensor information’.

Furthermore, in a case where the sensor detection information is not included in the first button selection information, the third acquisition unit 42 may transmit a sensor detection information transmission request to request the terminal device 2 to transmit the sensor detection information, and acquire the sensor detection information transmitted from the terminal device 2 according to the sensor detection information transmission request.

### 3.3.3. Generation Unit 32

The generation unit 32 generates, on the basis of information acquired by the acquisition unit 31, answer information to the user U or input information to be input to the generative AI, for example.

For example, on the basis of information corresponding to information indicating an intention type and information indicating an intention that have been acquired by the second acquisition unit 41 of the acquisition unit 31, the generation unit 32 generates answer information to the user U.

Furthermore, the generation unit 32 generates information that is information corresponding to sensor detection information acquired by the acquisition unit 31 and that is included in input information to be input to the generative AI.

The generation unit 32 has a first generation unit 43 and a second generation unit 44, each of which will hereinafter be described specifically.

### 3.3.3.1. First Generation Unit 43

On the basis of information corresponding to output information acquired by the second acquisition unit 41, the first generation unit 43 generates answer information corresponding to input information.

For example, on the basis of information corresponding to information indicating an intention type and information indicating an intention that have been acquired as the information corresponding to the output information by the second acquisition unit 41, the first generation unit 43 generates the answer information.

For example, it is now supposed that the intention type indicated by the information indicating the intention type is search and the information acquired as the information corresponding to the output information by the second acquisition unit 41 is a search result acquired from the search server 4. It is also supposed that the search result includes information on a character string, ‘“id”: “r000093218”’, information on a character string, ‘“name”: “ABC Fresh Seafood”’, and information on a character string, ‘“description”: “You can enjoy delicious dishes prepared using tuna direct from the fishing port!”’. The information on the character string, ‘“id”: “r000093218”’, is information indicating a restaurant ID.

In this case, the first generation unit 43 generates, as answer information, for example, information on a character string, ‘One seafood restaurant from 6 p.m., Oct. 16, 2023, has been found near your current location. YnYn @ABC Fresh Seafood ¥n You can enjoy delicious dishes prepared using tuna direct from the fishing port!’.

It is now supposed that the intention type indicated by the information indicating the intention type is question and the information acquired as the information corresponding to the output information by the second acquisition unit 41 is information acquired from the generative AI. In this case, the first generation unit 43 generates, as answer information, information including the information acquired from the generative AI.

For example, it is supposed that the information acquired from the generative AI includes information on a character string, ‘“description”: “ABC Fresh Seafood provides excellent lobster dishes. Lobsters are sautéed with butter and garlic and their rich taste spreads in your whole mouth. Fresh tuna steak is also another dish we would like you to try.’.

In this case, the first generation unit 43 generates, as the answer information, information on a character string, ‘” answer “: “ABC Fresh Seafood provides excellent lobster dishes. Lobsters are sautéed with butter and garlic and their rich taste spreads in your whole mouth. Fresh tuna steak is also another dish we would like you to try. “’.

Furthermore, in a case where function specification information is not acquired by the first acquisition unit 40, the first generation unit 43 generates, as the answer information, information indicating an error. For example, the first generation unit 43 generates, as the answer information, for example, information on a character string, ‘Unfortunately, it is not processible and an answer cannot be provided.’, or information on a character string, ‘Please make input on a restaurant search, a restaurant-related question, or a restaurant reservation.’.

For example, in a case where the generative AI is GPT of OpenAI, if the output information from the generative AI is not a function calling response, function specification information is not acquired by the first acquisition unit 40, and the first generation unit 43 thus generates, as the answer information, information indicating an error. A function calling response includes, for example, information on a character string, ‘“finish_reason”: “function_call”’, and the first acquisition unit 40 determines whether or not the output information from the generative AI is a function calling response on the basis of the information on the character string, ‘“finish_reason”: “function_call”’, and acquires function specification information.

### 3.3.3.2. Second Generation Unit 44

The second generation unit 44 generates and updates dialogue data as information for having a dialogue with a user U.

The dialogue data are, for example, data having, added therein, a history of dialogues with the user U in the past, variable information on the user U, and information indicating a specific event, and are generated, for example, in units of dialogues with the user U. The units of dialogues are each a unit that has been divided into a time period from a start to an end of a dialogue with the user U.

The variable information on the user U is, for example, information indicating a location of the user U but is not limited to this example. The dialogue data are information in a predetermined format, and are, for example, structured information (structure data) that is able to be readily searched through or analyzed. The structured information (structured data) is, for example, structured information (structured data) in the JSON format, but is not limited to this example.

In a case where an argument in function specification information is specific information, the information indicating a specific event is, for example, information indicating that the argument in the function specification information is the specific information, and the information indicating a specific event includes information indicating an event type and information indicating an event. The information indicating an event type is, for example, information indicating lack of the location of the user U.

The information indicating an event is, for example, information on a character string, ‘search’, information on a character string, ‘seafood restaurant’, and information on a character string, ‘user location’. The information on the character string, ‘search’, is information indicating an intention type, and the information on the character string, ‘seafood restaurant’, and the information on the character string, ‘user location’, are information indicating an intention.

A user dialogue history input as a dialogue history of the user U to the generative AI and a generative AI dialogue history input as a dialogue history of the generative AI to the generative AI are added to the history of dialogues in the dialogue data.

On the basis of output information from the generative AI acquired by the first acquisition unit 40 of the acquisition unit 31, the second generation unit 44 generates a user dialogue history that is input as the history of dialogues with the user U to the generative AI. The second generation unit 44 adds the user dialogue history generated, to the dialogue data.

For example, on the basis of information indicating an intention type and information indicating an intention that have been acquired by the first acquisition unit 40, the second generation unit 44 generates, as a user dialogue history, the information indicating the intention type and the information indicating the intention, and adds the user dialogue history generated, to the dialogue data.

Furthermore, on the basis of information corresponding to output information acquired by the second acquisition unit 41 of the acquisition unit 31, the second generation unit 44 generates a generative AI dialogue history to be input as a dialogue history of the generative AI to the generative AI.

For example, on the basis of the information corresponding to the output information acquired by the second acquisition unit 41 of the acquisition unit 31, the second generation unit 44 generates, as the generative AI dialogue history, the information indicating the intention type, information indicating a target to be processed, the information indicating the intention, and the output information from the generative AI, and adds the generative AI dialogue history generated, to the dialogue data.

In a case where a predetermined condition is satisfied, the second generation unit 44 deletes part of the history of dialogues included in the dialogue data, to minimize increase in the amount of data in the dialogue data. For example, in a case where the dialogue data include search information and new search information is to be added to the dialogue data, the second generation unit 44 deletes old search information from the dialogue data.

For example, it is now supposed that information on a character string, ‘make it a yakiniku restaurant instead’, has been transmitted as input information from the user U, from the terminal device 2 to the information processing apparatus 1 in a case where the dialogue data are in a state illustrated by (b2) in FIG. 1. In this case, on the basis of this input information, the generative AI outputs, as information indicating an intention type, information specifying a function related to a search, and outputs, as information on arguments of this function, information on a character string, ‘“query”: “yakiniku restaurant”’, instead of information on a character string, ‘“query”: “seafood restaurant”’.

The second acquisition unit 41 transmits, as a search condition, a search query including information indicating a restaurant type, “yakiniku restaurant”, to the search server 4, and acquires a search result from the search server 4. On the basis of a search intention acquired by the first acquisition unit 40 and the search result acquired by the second acquisition unit 41, the second generation unit 44 deletes search information on the last search from the dialogue data and adds search information on the current search to the dialogue data.

In this case, the search information on the last search deleted from the dialogue data is information on a character string, ‘“intent”: “search”, “condition”: {“query”: “seafood restaurant”, “location”: “USER_LOCATION”, “date”: “20231016”, “time”: “18:00”}, “restaurants”: {“id”: “r000093218”, “name”: “ABC Fresh Seafood”, “description”: “You can enjoy delicious seafood direct from the fishing port! “’.

Furthermore, the search information on the current search to be added to the dialogue data is, for example, information on a character string, ‘” intent “: “search”, “condition”: {“query”: “yakiniku restaurant”, “location”: “USER_LOCATION”, “date”: “20231016”, “time”: “18:00”}, “restaurants”: {“id”: “r000287231”, “name”: “Hishakaku in Akasaka”, “description”: “All-you-can-eat grade A5 yakiniku!”’.

Furthermore, in a case where a predetermined condition is that a search condition has changed by a prescribed range or more and the predetermined condition is satisfied, the second generation unit 44 may delete all of the past search information from the dialogue data. The prescribed range is, for example, a range within a prefecture or a predetermined range in a case where the search condition is a condition for a location; or a range within a restaurant genre group in a case where the search condition is a condition for a restaurant type, but the prescribed range is not limited to these examples.

Furthermore, in a case where the dialogue data include question information and new search information is to be added to the dialogue data, the second generation unit 44 may delete, in addition to a past search condition included in the dialogue data, the question information included in the dialogue data. As a result, the amount of data in the history of dialogues included in the dialogue data is able to be prevented from increasing too much.

### 3.3.4. Provision Unit 33

The provision unit 33 provides various kinds of information to a user U by transmitting the various kinds of information to a terminal device 2.

For example, the provision unit 33 provides answer information generated by the first generation unit 43 of the generation unit 32 to the user U and provides various buttons to the user U. The provision unit 33 has a display control unit 45 that displays the answer information generated by the first generation unit 43 or the various buttons, in a chat room.

### 3.3.4.1. Display Control Unit 45

By transmitting the answer information generated by the first generation unit 43 to the terminal device 2, the display control unit 45 causes the answer information generated by the first generation unit 43 to be displayed in the chat room displayed on the terminal device 2.

Furthermore, by transmitting button information to the terminal device 2, the display control unit 45 causes the terminal device 2 to display buttons for acquiring, from the terminal device 2, sensor detection information that is information detected by a built-in sensor in the terminal device 2, the built-in sensor not being illustrated in the drawings. The button information is, for example, the first button information and second button information mentioned above, and the buttons are, for example, the first button and the second button mentioned above. The display control unit 45 is thus able to cause the terminal device 2 to display the buttons for acquiring the sensor detection information from the terminal device 2 of the user U in the service in the dialogue format using the generative AI that outputs answer information corresponding to input information.

The display control unit 45 causes the terminal device 2 to display a button on the basis of output information from the generative AI acquired by the acquisition unit 31, for example. For example, in a case where the output information from the generative AI acquired by the acquisition unit 31 includes information on a specific character string, the display control unit 45 causes the terminal device 2 to display the first button by transmitting the first button information to the terminal device 2. The information on a specific character string is, for example, information on a character string, ‘USER_LOCATION’, but is not limited to this example.

### 4. EXAMPLE OF PROCESSING BY PROCESSING UNIT 12

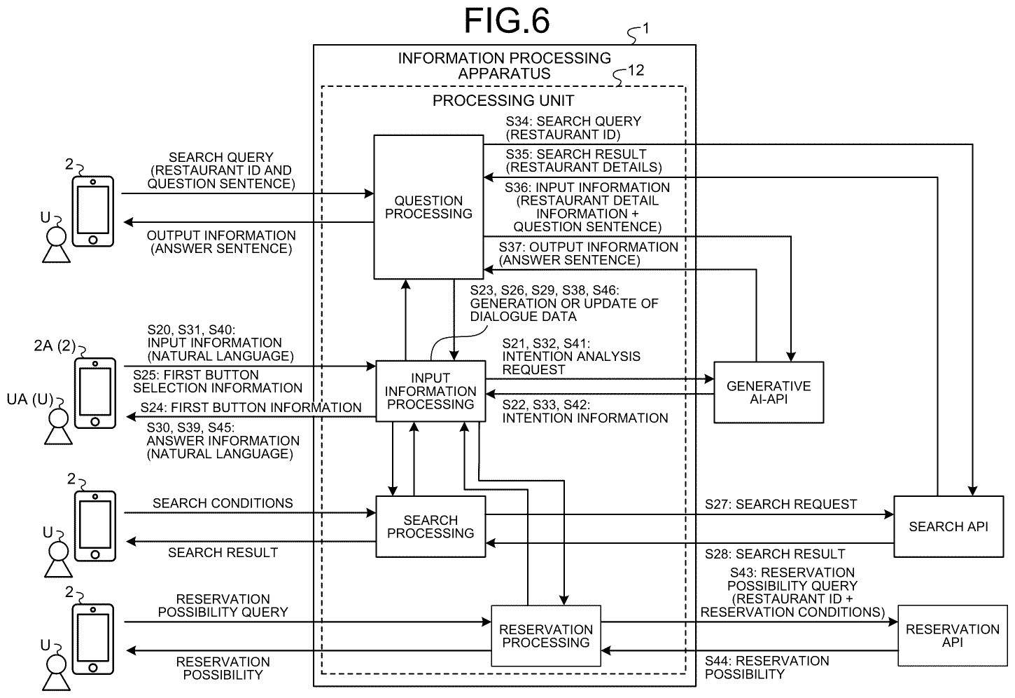

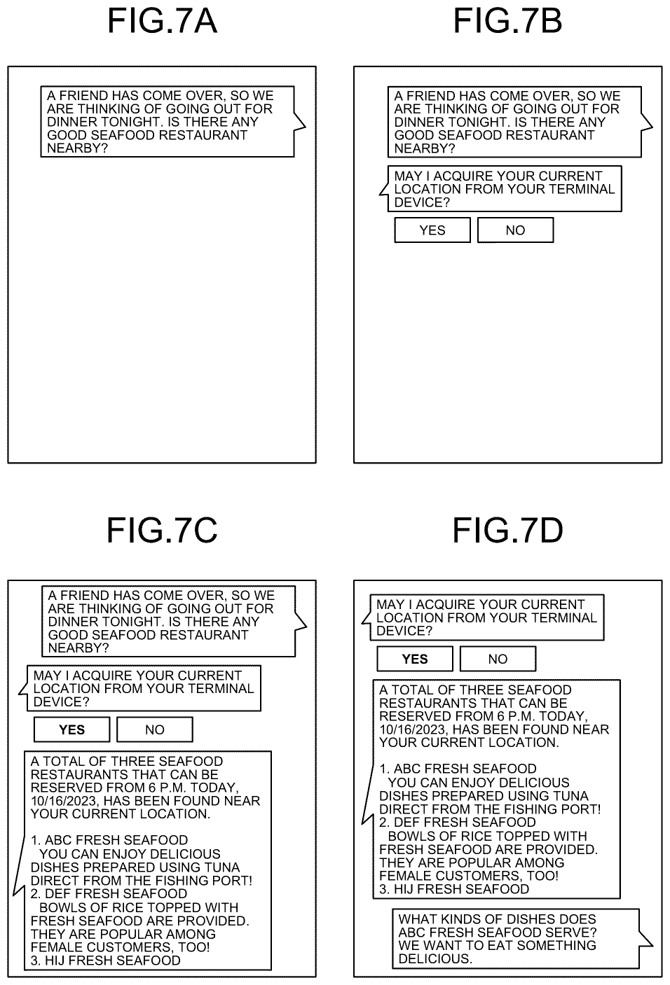

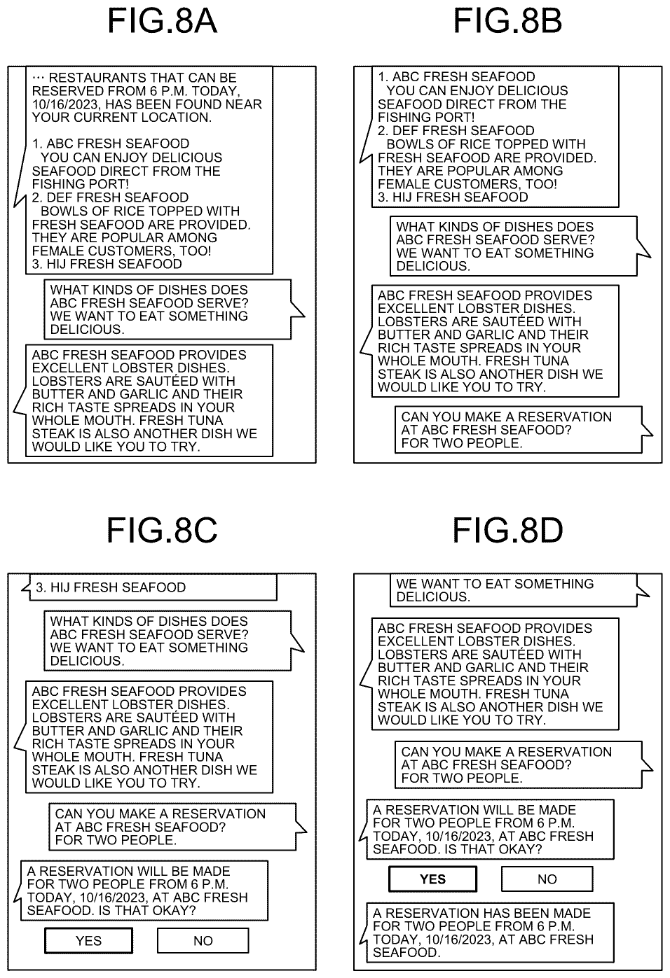

FIG. 6 is a diagram for description of an example of processing by the processing unit 12 of the information processing apparatus 1 according to the embodiment. FIG. 7 and FIG. 8 are diagrams each illustrating an example of information positioned in a chat room displayed on a terminal device 2 according to the embodiment. In FIG. 6, one of four terminal devices 2 is referred to as a terminal device 2A for convenience, and a user U of the terminal device 2A as a user UA.

As illustrated by FIG. 7A, when the user UA operates the terminal device 2A to input a character string in the chat room, as illustrated in FIG. 6, information on the character string input by the user UA is transmitted as input information from the terminal device 2A to the information processing apparatus 1.

In an example illustrated by FIG. 7A, information on a character string, ‘A friend is coming over, so I am thinking of going out for dinner with the friend. Is there any good seafood restaurant?’, is transmitted as the input information to the information processing apparatus 1.

The reception unit 30 in the processing unit 12 of the information processing apparatus 1 receives the input information transmitted from the terminal device 2A (Step S20). The first acquisition unit 40 in the acquisition unit 31 of the processing unit 12 inputs, as an intention analysis request, information including the input information received at Step S20, to the generative AI through the generative AI-API (Step S21), and acquires, as output information, intention information corresponding to the intention analysis request, from the generative AI through the generative AI-API (Step S22).

For example, at Step S21, the acquisition unit 31 inputs information including user input information and intention definition information for extracting an intention type and an intention from the input information, to the generative AI through the generative AI-API. At Step S22, the acquisition unit 31 then acquires, as output information, intention information including information indicating the intention type and information indicating the intention, from the generative AI through the generative AI-API.

In FIG. 6, the generative AI that inputs and outputs information through the generative AI-API is generative AI that has been trained to output, as output information, intention information in a case where information including user information and definition information has been input. The definition information is information defining each of plural functions.

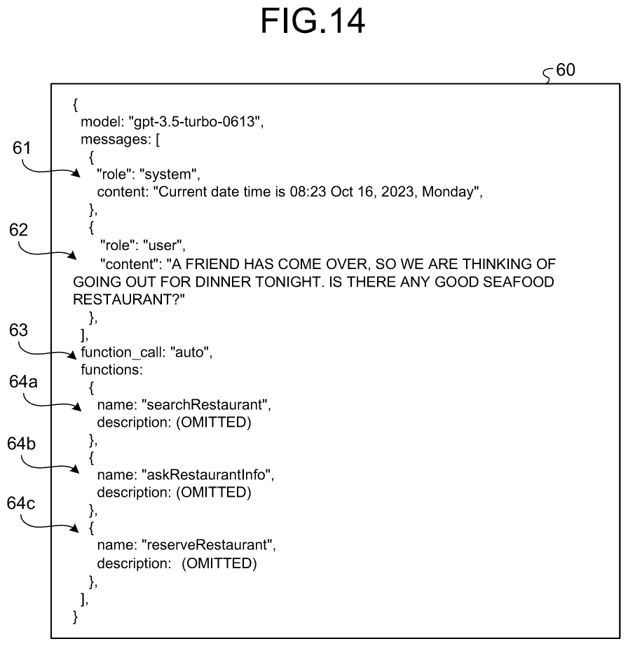

FIG. 14 is a diagram illustrating an example of input information that is information input to the generative AI by the acquisition unit 31 in the processing unit 12 of the information processing apparatus 1 according to the embodiment. Input information 60 illustrated in FIG. 14 includes time and date information 61, user input information 62, function instruction information 63, function information 64a, function information 64b, and function information 64c.

In FIG. 14, the time and date information 61 is information indicating the current time, and the user input information 62 is input information from the user UA and information on a character string, ‘A friend has come over, so we are thinking of going out for dinner tonight. Is there any good seafood restaurant?’.

The example illustrated in FIG. 14 is an example of a case where the generative AI is a large language model called GPT-3.5 Turbo of OpenAI, and the function instruction information 63 includes, as information for causing function specification information to be output from the generative AI, information on a character string, ‘function_call: “auto”’.

Furthermore, in the example illustrated in FIG. 14, the function information 64a that is information on a function related to a search and indicated by a function name, ‘searchRestaurant”, the function information 64b that is information on a function related to a question and indicated by a function name, ‘askRestaurantInfo’, and the function information 64c that is information on a function related to a reservation and indicated by a function name, ‘reserveRestaurant’ are included. Information defining specific arguments of the functions of the function information 64a, function information 64b, and function information 64c illustrated in FIG. 14 has been omitted by means of information on a character string, ‘(omitted)’.

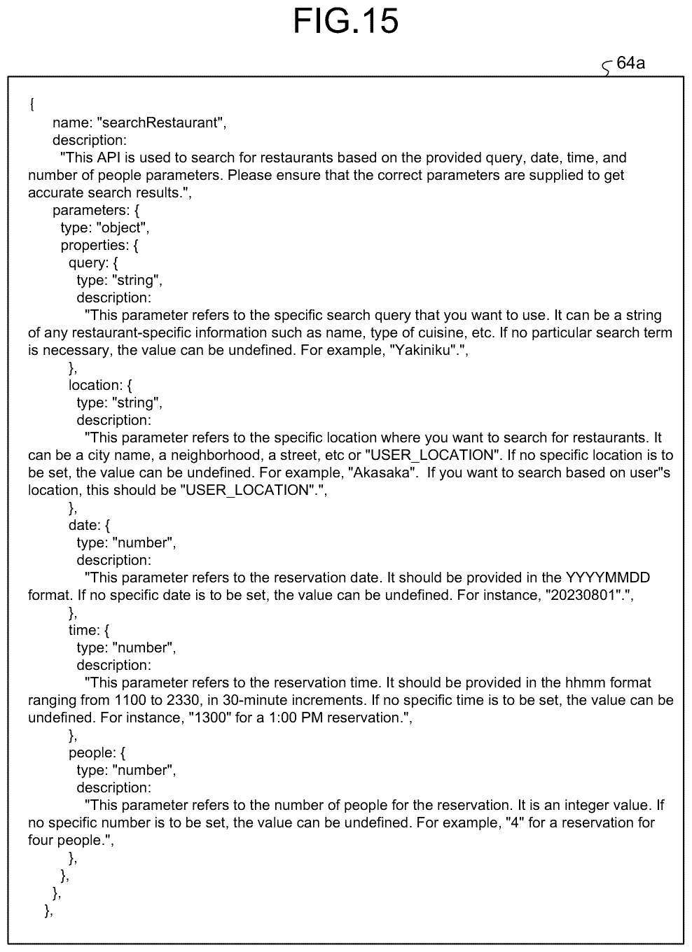

FIG. 15 is a diagram illustrating an example of information on a function related to a search included in function information illustrated in FIG. 14. The function information 64a illustrated in FIG. 15 is information defining the function related to the search, and includes: as information specifying the function name, the information on the character string, ‘askRestaurantInfo’; and as information on arguments (parameters) of the function related to the search, information on ‘query’ (restaurant type), information on ‘location’ (location), information on ‘date’ (dining date), information on ‘time’ (dining time and date), and information on ‘people’ (number of people dining).

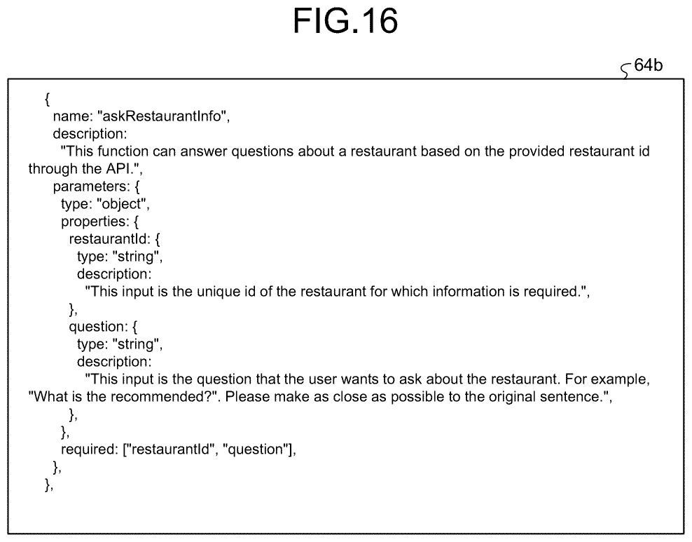

FIG. 16 is a diagram illustrating an example of information on a function related to a question included in function information illustrated in FIG. 14. The function information 64b illustrated in FIG. 16 is the information defining the function related to the question, and includes: as the information specifying the function name, the information on the character string, ‘searchRestaurant’; and as information on arguments (parameters) of the function related to the question, information on ‘restaurantId’ (restaurant ID) and information on ‘question’ (question).

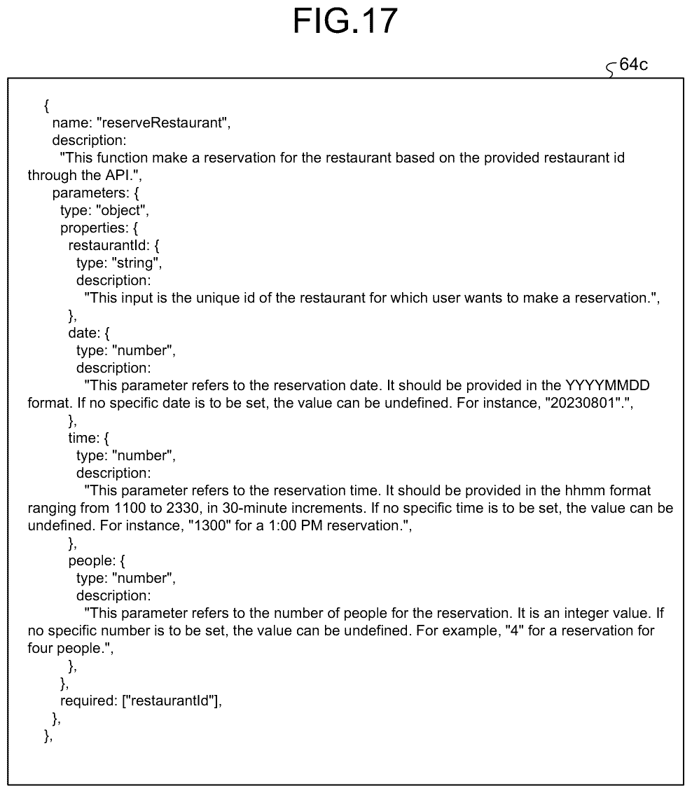

FIG. 17 is a diagram illustrating an example of information on a function related to a reservation included in function information illustrated in FIG. 14. The function information 64c illustrated in FIG. 17 is the information defining the function related to the reservation and includes: as the information specifying the function name, the information on the character string, ‘reserveRestaurant’; and as information on arguments (parameters) of the function related to the reservation, information on ‘restaurantId’ (restaurant ID), information on ‘date’ (dining date), information on ‘time’ (dining time), and information on ‘people’ (number of people dining).

In a case where information on a character string, ‘A friend is coming over, so I am thinking of going out for dinner with the friend. Is there any good seafood restaurant?’, has been transmitted as input information to the information processing apparatus 1, the generative AI outputs, as output information, function specification information including information specifying a function related to a search and information specifying arguments of the function related to the search.

On the basis of the output information acquired at Step S22, the information processing apparatus 1 generates, as information for having a dialogue with the user UA, dialogue data (Step S23). The dialogue data are, for example, data having, added therein, a history of dialogues with the user U in the past, variable information on the user UA, and information indicating a specific event, and are generated, for example, in units of dialogues with the user UA. The units of dialogues are each a unit that has been divided into a time period from a start to an end of a dialogue with the user UA.

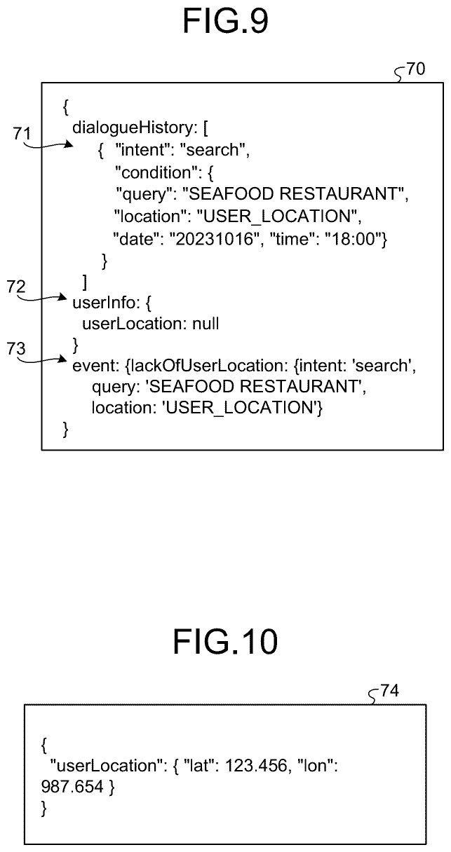

FIG. 9 is a diagram illustrating an example of dialogue data generated by the generation unit 32 in the processing unit 12 of the information processing apparatus 1 according to the embodiment. Dialogue data 70 illustrated in FIG. 9 include search information 71, user variable information 72, and event information 73.

The search information 71 is information related to a search and includes information indicating an intention type and information indicating an intention. The search information 71 includes, as the information indicating the intention type, information on a character string, ‘” intent “: “search”’, and includes, as the information indicating the intention, information on a character string, ‘“query”: “seafood restaurant”’, information on a character string, ‘USER_LOCATION’, information on a character string, ‘“date”: “20231016”’, and information on a character string, ‘“time”: “18:00”’.

The user variable information 72 includes information indicating that a location of the user UA has not been set. The event information 73 includes, as information indicating an event type, information on a character string, ‘lackOfUserLocation “, that is information indicating the lack of the location of the user UA, and includes, as information indicating an event, information indicating that the search type is search, the restaurant type is seafood restaurant, and the location is a location of the user UA.

Subsequently, in a case where the information indicating the lack of the location of the user UA is included as the event information 73 in the dialogue data 70, the display control unit 45 in the provision unit 33 of the processing unit 12 transmits the first button information to the terminal device 2A and causes the first button to be displayed in a chat room being displayed on the terminal device 2A (Step S24).

In an example illustrated by FIG. 7B, information representing a character string, ‘May I acquire your current location from your terminal device?’, the first button including information on a character string, ‘yes’, and the second button including information on a character string, ‘no’, are displayed in the chat room.

In a case where the user UA operates the terminal device 2A to select the first button by tapping on the first button, for example; by means of a function of a communication application, the terminal device 2A acquires location information that is data indicating the current location from a built-in location sensor and transmits first button selection information including, as location information on the user UA, the location information acquired, to the information processing apparatus 1.

The first button selection information is information indicating that the first button has been selected by the user UA and includes, as the location information on the user UA, data indicating the current location of the user UA by latitude and longitude, but the location information on the user UA may be not included in the first button selection information. In that case, the third acquisition unit 42 requests the terminal device 2A to transmit the location information in response to the first button having been selected.

In a case where the user UA operates the terminal device 2A to select the second button by tapping on the second button, the terminal device 2A transmits second button selection information that is information indicating that the second button has been selected by the user UA, to the information processing apparatus 1.

The third acquisition unit 42 in the acquisition unit 31 of the processing unit 12 acquires the first button selection information transmitted from the terminal device 2A (Step S25). In a case where the first button selection information has been acquired by the third acquisition unit 42, the second generation unit 44 in the generation unit 32 of the processing unit 12 updates the dialogue data 70 on the basis of the location information indicated by the first button selection information (Step S26).

FIG. 10 is a diagram illustrating an example of location information added as variable information on the user UA to the dialogue data 70 by the generation unit 32 in the processing unit 12 of the information processing apparatus 1 according to the embodiment. In the example illustrated in FIG. 10, information on a character string, ‘” userLocation “: {” lat “: 123.456, “lon”: 987.654}’, is included as location information 74 to be added to the dialogue data 70.

In a case where the location information 74 is to be added to the dialogue data 70, the second generation unit 44 deletes the information indicating the lack of the location of the user UA (for example, the event information 73 illustrated in FIG. 9) from the dialogue data 70. The location information 74 is an example of user variable information. The second generation unit 44 thereby enables reduction in the amount of data in the dialogue data 70.

The first generation unit 43 in the generation unit 32 generates a search query including, in search condition information, the location information indicated by the first button selection information received by the reception unit 30 and the information indicating the intention indicated by the output information acquired at Step S22. The second acquisition unit 41 in the acquisition unit 31 of the processing unit 12 then transmits the search query generated by the first generation unit 43 to the search server 4 through the search API (Step S27).

At Step S27, because the function specified by the function specification information acquired by the first acquisition unit 40 at Step S22 is a function related to a search, the second acquisition unit 41 transmits the search query including, as information on search conditions, the information on the arguments included in the function specification information acquired by the first acquisition unit 40 and the location information indicated by the first button selection information, to the search server 4 through the search API.

The second acquisition unit 41 acquires a search result corresponding to the search query from the search server 4 through the search API (Step S28). The second generation unit 44 in the generation unit 32 of the processing unit 12 then updates the dialogue data 70, on the basis of the search result acquired by the second acquisition unit 41 at Step S28 (Step S29).

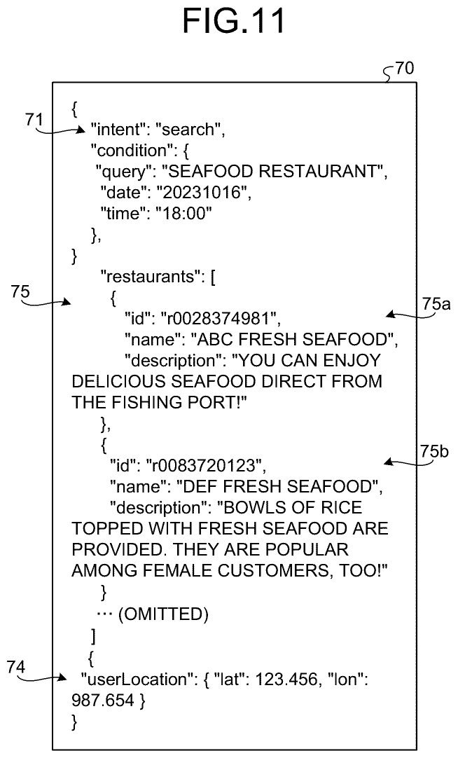

FIG. 11 is a diagram illustrating an example of the dialogue data 70 updated by the generation unit 32 in the processing unit 12 of the information processing apparatus 1 according to the embodiment. The dialogue data 70 illustrated in FIG. 11 include the search information 71 arranged at Step S23, the location information 74 added at Step S26, and a search result 75 added at Step S29.

The search result 75 illustrated in FIG. 11 includes plural sets of restaurant information 75a and 75b, for example. The set of restaurant information 75a includes information on a character string, ‘“id”: “r0028374981”’ (restaurant ID), information on a character string, ‘“name”: “ABC Fresh Seafood”’ (restaurant name), and information on, ‘“You can enjoy delicious dishes prepared using tuna direct from the fishing port!’ (restaurant details).

The set of restaurant information 75b includes information on a character string, ‘“id”: “r0083720123”’ (restaurant ID), information on a character string, ‘“name”: “DEF Fresh Seafood”’ (restaurant name), and information on ‘“Bowls of rice topped with fresh seafood are provided. They are popular among female customers, too!’ (restaurant details). The third and later sets of restaurant information have been omitted in the search result 75 illustrated in FIG. 11.

The second generation unit 44 may generate the dialogue data 70 by performing the processing at Step S23 and the processing at Step S26 collectively at Step S29.

Subsequently, on the basis of the search result acquired by the second acquisition unit 41 at Step S23, the first generation unit 43 in the generation unit 32 of the processing unit 12 generates answer information, and the display control unit 45 in the provision unit 33 of the processing unit 12 causes the terminal device 2A of the user UA to display the answer information generated by the first generation unit 43 (Step S30).

The terminal device 2A receives the answer information transmitted by the display control unit 45 and displays the answer information received. In an example illustrated by FIG. 7C, information on a character string, ‘A total of three seafood restaurants that can be reserved from 6 p.m. today, Oct. 16, 2023, has been found near your current location. 1. ABC Fresh Seafood You can enjoy delicious dishes prepared using tuna direct from the fishing port! 2. DEF Fresh Seafood ¥n Bowls of rice topped with fresh seafood are provided. They are popular among female customers, too! 3. HIJ Fresh Seafood . . . ’, is being displayed as the answer information in the chat room displayed on the terminal device 2A.

As illustrated by FIG. 7D, when the user UA operates the terminal device 2A to input a character string in the chat room, as illustrated in FIG. 6, information on the character string input by the user UA is transmitted as input information from the terminal device 2A to the information processing apparatus 1. In the example illustrated by FIG. 7D, information on a character string, ‘What kinds of dishes does ABC Fresh Seafood serve? We want to eat something delicious.’, is transmitted as the input information to the information processing apparatus 1.

The reception unit 30 in the processing unit 12 of the information processing apparatus 1 receives the input information transmitted from the terminal device 2A (Step S31). The first acquisition unit 40 in the acquisition unit 31 of the processing unit 12 inputs, as an intention analysis request, information including the input information received at Step S31, to the generative AI through the generative AI-API (Step S32).

For example, at Step S32, the first acquisition unit 40 inputs information including user input information and intention definition information for extracting an intention type and an intention from the input information, to the generative AI through the generative AI-API. The acquisition unit 31 then acquires, as output information, intention information including information indicating the intention type and information indicating the intention, from the generative AI through the generative AI-API, at Step S33.

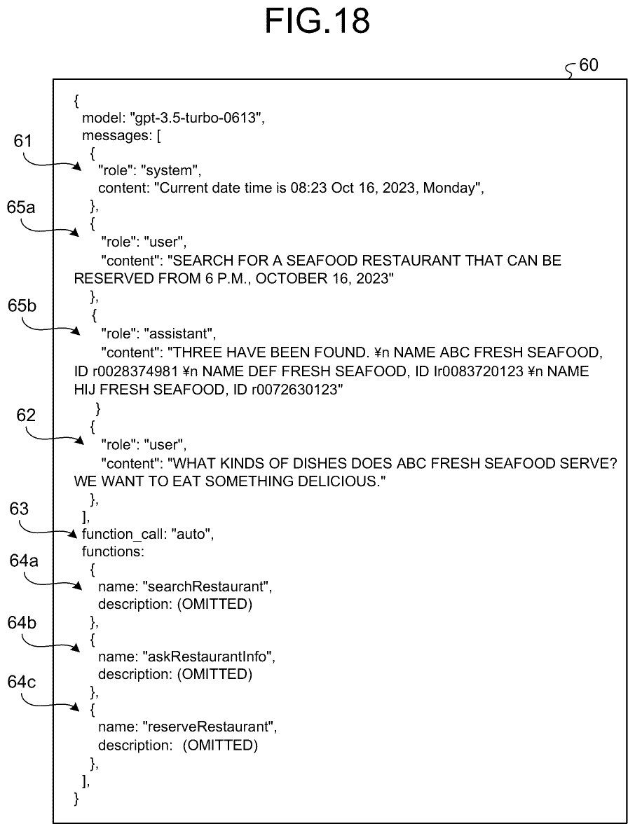

FIG. 18 is a diagram illustrating another example of the input information that is information input to the generative AI by the acquisition unit 31 in the processing unit 12 of the information processing apparatus 1 according to the embodiment. Input information 60 illustrated in FIG. 18 includes time and date information 61, user input information 62, function instruction information 63, function information 64a, function information 64b, function information 64c, and dialogue histories 65a and 65b.

In FIG. 18, the user input information 62 is information on a character string, ‘What kinds of dishes does ABC Fresh Seafood serve? We want to eat something delicious.’ and is the input information received by the reception unit 30 at Step S31.

The dialogue history 65a is a user dialogue history, and in the example illustrated in FIG. 18, is information on a character string, ‘Search for a seafood restaurant that can be reserved from 6 p.m., Oct. 16, 2023.’. The first generation unit 43 generates the user dialogue history on the basis of the search information 71 included in the dialogue data 70 illustrated in FIG. 11.

The second generation unit 44 is thereby able to appropriately add information indicating the time and date while reducing the number of characters, as compared to a case where information on a character string, ‘A friend has come over, so we are thinking of going out for dinner tonight. Is there any good seafood restaurant?’, is generated as the user dialogue history.

The dialogue history 65b is a generative AI dialogue history, and in the example illustrated in FIG. 18, the dialogue history 65b is information on a character string, ‘Three have been found. ¥n Name ABC Fresh Seafood, ID r0028374981 Name DEF Fresh Seafood, ID Ir0083720123 ¥n Name HIJ Fresh Seafood ID r0072630123’. The first generation unit 43 generates the generative AI dialogue history on the basis of the search result 75 included in the dialogue data 70 illustrated in FIG. 11.

The second generation unit 44 thereby generates, as the generative AI dialogue history, a search result corresponding to intention information, instead of intention information generated by the generative AI, and thus enables a history of dialogues with the user UA to be more appropriate than in a case where the intention information is generated as the generative AI dialogue history. Furthermore, because the second generation unit 44 does not include any descriptive sentence about any restaurant included in answer information to the user UA, the amount of information in the generative AI dialogue history is able to be reduced as compared to a case where the answer information to the user UA is generated as the generative AI dialogue history.

The second acquisition unit 41 of the acquisition unit 31 acquires, as output information, intention information corresponding to the intention analysis request, from the generative AI through the generative AI-API (Step S33). The intention information acquired at Step S33 includes information indicating an intention type and information indicating an intention.

The information indicating the intention type included in the intention information output from the generative AI is information indicating a function related to a question, and the information indicating the intention includes information on a restaurant ID that is information specifying a restaurant. The second acquisition unit 41 generates a search query including the restaurant ID as search condition information, the search query being for searching detailed information on the restaurant corresponding to the restaurant ID, and transmits the search query generated, to the search server 4 through the search API (Step S34).

The second acquisition unit 41 then acquires a search result corresponding to the search query from the search server 4 through the search API (Step S35). The search result includes, for example, detailed information on the restaurant corresponding to the restaurant ID indicated by the search query.

Subsequently, on the basis of the dialogue data, the user input information that has been received by the reception unit 30 at Step S31, and the search result acquired at Step S35, the second acquisition unit 41 generates input information to be input to the generative AI and inputs the input information generated, to the generative AI through the generative AI-API (Step S36).

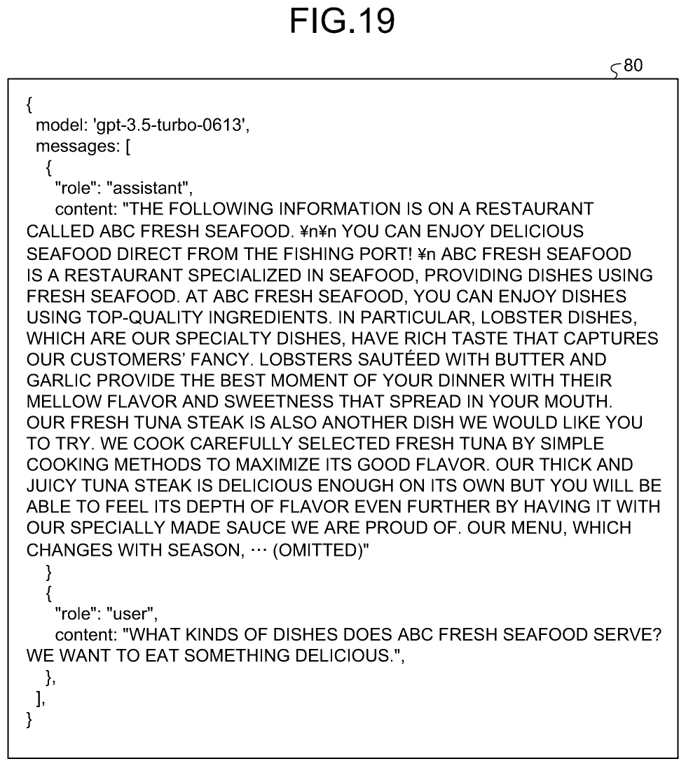

FIG. 19 is a diagram illustrating yet another example of the input information that is information input to the generative AI by the acquisition unit 31 in the processing unit 12 of the information processing apparatus 1 according to the embodiment. In input information 80 illustrated in FIG. 19, information on a character string, “The following information is on a restaurant called ABC Fresh Seafood. ¥n¥n You can enjoy delicious seafood direct from the fishing port!′, is information generated on the basis of the dialogue data.

Furthermore, in FIG. 19, information on a character string, ‘ABC Fresh Seafood is a restaurant specialized in seafood, providing dishes using fresh seafood . . . ’, is the search result acquired at Step S35. Furthermore, in FIG. 19, information on a character string, ‘What kinds of dishes does ABC Fresh Seafood serve? We want to eat something delicious.’, is the user input information received by the reception unit 30 at Step S31.

The second acquisition unit 41 acquires output information corresponding to the input information, from the generative AI through the generative AI-API (Step S37). On the basis of the input information received by the reception unit 30 at Step S31, the search result acquired by the second acquisition unit 41 at Step S35, and the output information from the generative AI acquired by the second acquisition unit 41 at Step S37, the second generation unit 44 of the generation unit 32 updates the dialogue data 70 (Step S38).

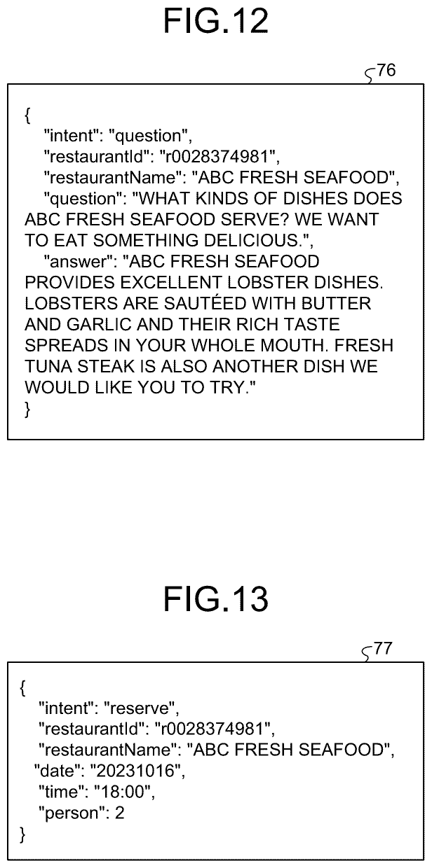

FIG. 12 is a diagram illustrating an example of a dialogue history added to the dialogue data 70 by the generation unit 32 in the processing unit 12 of the information processing apparatus 1 according to the embodiment. A dialogue history 76 illustrated in FIG. 12 includes: as information indicating an intention type, information on a character string, ‘“intent”: “question”’; as information on a restaurant ID, information on a character string, ‘“restaurantId”: “r0028374981”’: as information on a restaurant name, information on a character string ‘“restaurantName”: “ABC Fresh Seafood”’; and as a user dialogue history, information on a character string, ‘What kinds of dishes does ABC Fresh Seafood serve? We want to eat something delicious.’. This user dialogue history is the input information received by the reception unit 30 at Step S31.

The dialogue history 76 illustrated in FIG. 12 includes, as an AI dialogue history, information on a character string, ‘ABC Fresh Seafood provides excellent lobster dishes. Lobsters are sautéed with butter and garlic and their rich taste spreads in your whole mouth. Fresh tuna steak is also another dish we would like you to try.’. This AI dialogue history is the output information from the generative AI acquired by the second acquisition unit 41 at Step S37.

Subsequently, on the basis of the output information from the generative AI acquired by the second acquisition unit 41 at Step S37, the first generation unit 43 in the generation unit 32 of the processing unit 12 generates answer information, and the display control unit 45 in the provision unit 33 of the processing unit 12 causes the terminal device 2A of the user UA to display the answer information generated by the first generation unit 43 (Step S39).

The terminal device 2A receives the answer information transmitted by the display control unit 45 and displays the answer information received. In an example illustrated by FIG. 8A, information on a character string, ‘ABC Fresh Seafood provides excellent lobster dishes. Lobsters are sautéed with butter and garlic and their rich taste spreads in your whole mouth. Fresh tuna steak is also another dish we would like you to try.’, is being displayed as the answer information in a chat room displayed on the terminal device 2A.

As illustrated by FIG. 8B, when the user UA operates the terminal device 2A to input a character string in the chat room, as illustrated in FIG. 6, information on the character string input by the user UA is transmitted as input information from the terminal device 2A to the information processing apparatus 1. In the example illustrated by FIG. 8B, information on a character string, ‘Can you make a reservation at ABC Fresh Seafood? For two people.’, is transmitted as the input information to the information processing apparatus 1.

The reception unit 30 in the processing unit 12 receives the input information transmitted from the terminal device 2A (Step S40). The first acquisition unit 40 in the acquisition unit 31 of the processing unit 12 inputs, as an intention analysis request, information including the input information received at Step S31, to the generative AI through the generative AI-API (Step S41).

For example, at Step S40, the first acquisition unit 40 inputs information including user input information and intention definition information for extracting an intention type and an intention from the input information, to the generative AI through the generative AI-API. The acquisition unit 31 then acquires, as output information, intention information including information indicating the intention type and information indicating the intention, from the generative AI through the generative AI-API, at Step S41.

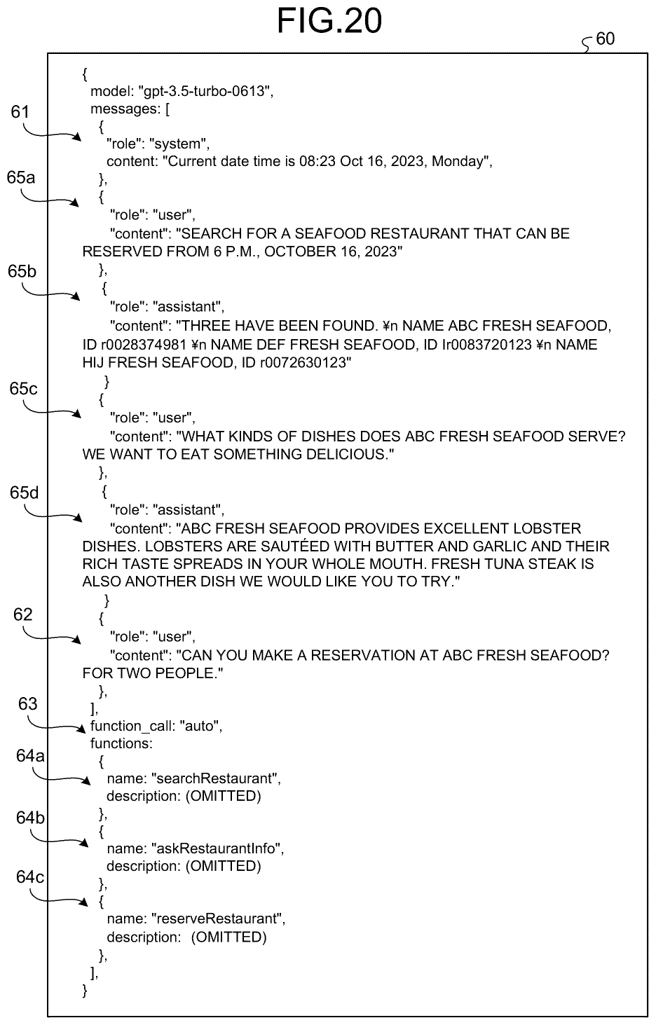

FIG. 20 is a diagram illustrating still another example of the input information that is information input to the generative AI by the acquisition unit 31 in the processing unit 12 of the information processing apparatus 1 according to the embodiment. Input information 60 illustrated in FIG. 20 includes time and date information 61, user input information 62, function instruction information 63, function information 64a, function information 64b, function information 64c, and dialogue histories 65a, 65b, 65c, and 65d.

The dialogue history 65c is the user input information 62 illustrated in FIG. 18 and the user input information 62 is used as a user dialogue history. The dialogue history 65d is the output information acquired by the second acquisition unit 41 at Step S37 and the output information is used as an AI dialogue history.

The second acquisition unit 41 acquires intention information that is the output information corresponding to the input information input to the generative AI at Step S41, from the generative AI through the generative AI-API (Step S42). In a case where the user input information received by the reception unit 30 at Step S40 is the user input information 62 illustrated in FIG. 20, the generative AI outputs, as the intention information, function specification information including information specifying a function related to a reservation and information specifying arguments of the function related to the reservation.

Information indicating an intention includes, as the information on the arguments of the function related to the reservation, for example: as a restaurant ID, information on a character string, ‘“id”: “r000093218”’; as a dining date, information on a character string, ‘2023 Oct. 16’; as a dining time, information on a character string, ‘18:00’; and as the number of people dining, information on a character string, ‘2’. The information on these arguments is reservation condition information that is information indicating reservation conditions.

Because information indicating an intention type indicated by the intention information acquired by the first acquisition unit 40 at Step S42 is the information specifying the function related to the reservation, the second acquisition unit 41 generates a reservation possibility query including information indicating reservation check conditions, and transmits the reservation possibility query generated, to the reservation server 5 through the reservation API (Step S43).

The reservation possibility query includes, for example: as the restaurant ID, the information on the character string, ‘“id”: “r000093218”’; as the dining date, the information on the character string, ‘2023 Oct. 16’; as the dining time, the information on the character string, ‘18:00’; and as the number of people dining, the information on the character string, ‘2’.

Subsequently, the second acquisition unit 41 acquires reservation possibility information corresponding to the reservation possibility query, from the reservation server 5 through the reservation API (Step S44). The reservation possibility information is, for example, information indicating whether or not a reservation at a restaurant specified by the reservation possibility query is possible under conditions specified by the reservation possibility query.

Subsequently, on the basis of the reservation possibility information acquired at Step S44, the display control unit 45 of the provision unit 33 transmits, as answer information, information indicating whether or not a reservation at the restaurant, for which the user UA has inquired about possibility of a reservation with the user input information from Step S40, is possible, to the terminal device 2A to cause the terminal device 2A to display the answer information (Step S45).

The terminal device 2A receives the answer information transmitted by the display control unit 45 and displays the answer information received. In an example illustrated by FIG. 8C, information on a character string, ‘A reservation will be made for two people from 6 p.m. today, Oct. 16, 2023, at ABC Fresh Seafood. Is that okay?’, is displayed as the answer information in the chat room displayed on the terminal device 2A.

Furthermore, as illustrated by FIG. 8C, the display control unit 45 causes the terminal device 2A to display two buttons for inquiring of the user UA whether or not the reservation can be finalized. The two buttons include a third button including information on a character string, ‘yes’, and a fourth button including information on a character string, ‘no’.

In a case where the user UA has operated the terminal device 2A to select the third button by tapping on the third button, for example, the terminal device 2A acquires, by means of a function of the communication application, location information that is data indicating the current location, from the built-in location sensor, and transmits third button selection information including, as location information on the user UA, the location information acquired, to the information processing apparatus 1.

The third acquisition unit 42 of the acquisition unit 31 acquires button information transmitted from the terminal device 2A and the second acquisition unit 41 of the acquisition unit 31 transmits information indicating finalization of the reservation, to the reservation server 5 through the reservation API. The reservation for ABC Fresh Seafood is thereby completed. As illustrated by FIG. 8D, the display control unit 45 causes the terminal device 2A to display, as the information indicating that the reservation has been finalized, information on a character string, ‘A reservation has been made for two people from 6 p.m. today, Oct. 16, 2023, at ABC Fresh Seafood.’.

In a case where the reservation for ABC Fresh Seafood has been completed, the second generation unit 44 of the generation unit 32 adds a reservation history indicating that the reservation for ABC Fresh Seafood has been completed, to the dialogue data 70 (Step S46). The reservation history is part of the history of dialogues.

FIG. 13 is a diagram illustrating an example of a reservation history added to the dialogue data 70 by the generation unit 32 in the processing unit 12 of the information processing apparatus 1 according to the embodiment. A dialogue history 77 illustrated in FIG. 13 includes: as the information indicating the intention type, information on a character string, ‘“intent”: “reserve”’; as the information on the restaurant ID, information on a character string, ‘“restaurantId”: “r0028374981’; as the information on the restaurant name, information on a character string, ‘” restaurantName “: “ABC Fresh Seafood”’; as the information on the dining date, information on a character string, ‘“date”: “20231016”’; as the information on the dining time, information on a character string, ‘“time”: “18:00”’; and as the information on the number of people dining, information on a character string, ‘“person”: “2”’.

As described above, because answer information to a user U is generated by the generation unit 32 of the information processing apparatus 1 and not by the generative AI, the answer information being other than answer information corresponding to a question related to a restaurant, for example, the information processing apparatus 1 will not include any nonexistent restaurant in a search result or will not answer that a reservation has been made when the reservation has not actually been made. Therefore, the information processing apparatus 1 enables operation preventing hallucination, which is a problem specific to generative AI.

### 5. PROCESSING PROCEDURE

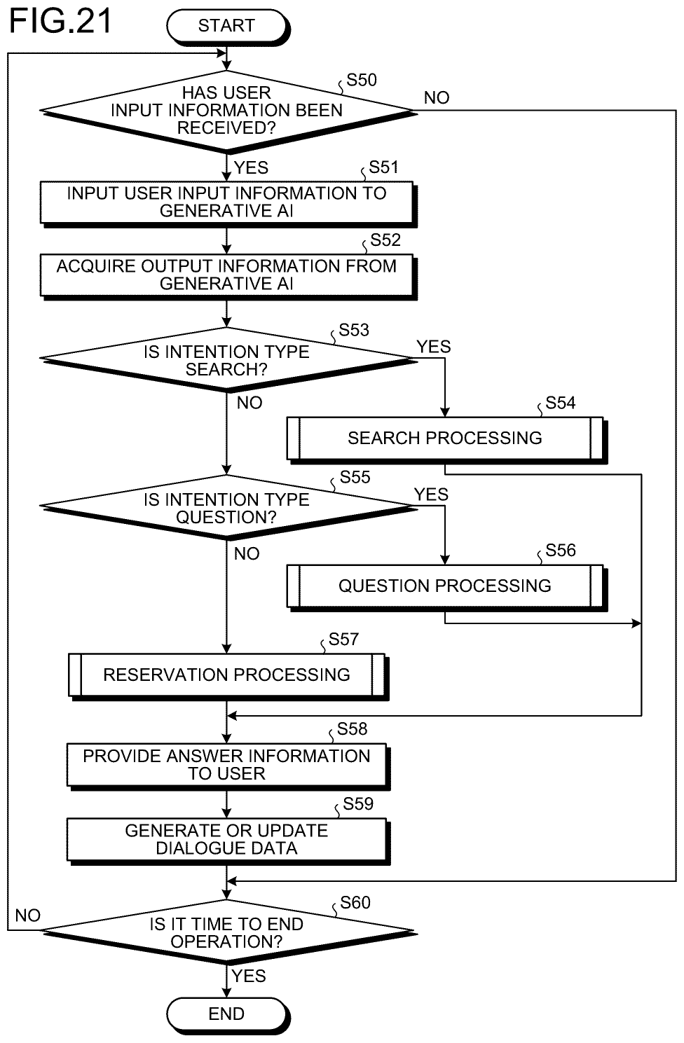

A procedure of information processing by the processing unit 12 of the information processing apparatus 1 according to the embodiment will be described next. FIG. 21 is a flowchart illustrating an example of the information processing by the processing unit 12 of the information processing apparatus 1 according to the embodiment.

As illustrated in FIG. 21, the processing unit 12 of the information processing apparatus 1 determines whether or not user input information that is input information transmitted from a terminal device 2 has been received (Step S50). In a case where the processing unit 12 determines that the user input information has been received (Step S50: Yes), the processing unit 12 inputs the user input information to the generative AI (Step S51) and acquires output information corresponding to the user input information from the generative AI (Step S52).

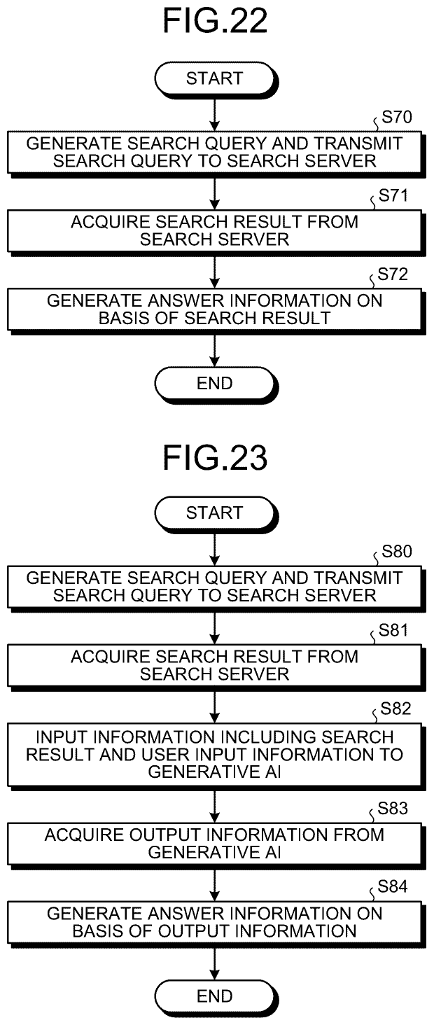

The processing unit 12 determines whether or not an intention type indicated by the output information acquired at Step S52 is search (Step S53). In a case where the processing unit 12 has determined that the intention type is search (Step S53: Yes), the processing unit 12 performs search processing (Step S54). The search processing at Step S54 is processing at Steps S70 to S72 illustrated in FIG. 22 and will be described in detail later.

In a case where the processing unit 12 has determined that the intention type is not search (Step S53: No), the processing unit 12 determines whether or not the intention type is question (Step S55). In a case where the processing unit 12 has determined that the intention type is question (Step S55: Yes), the processing unit 12 performs question processing (Step S56). The question processing at Step S56 is processing at Steps S80 to S84 illustrated in FIG. 23 and will be described in detail later.

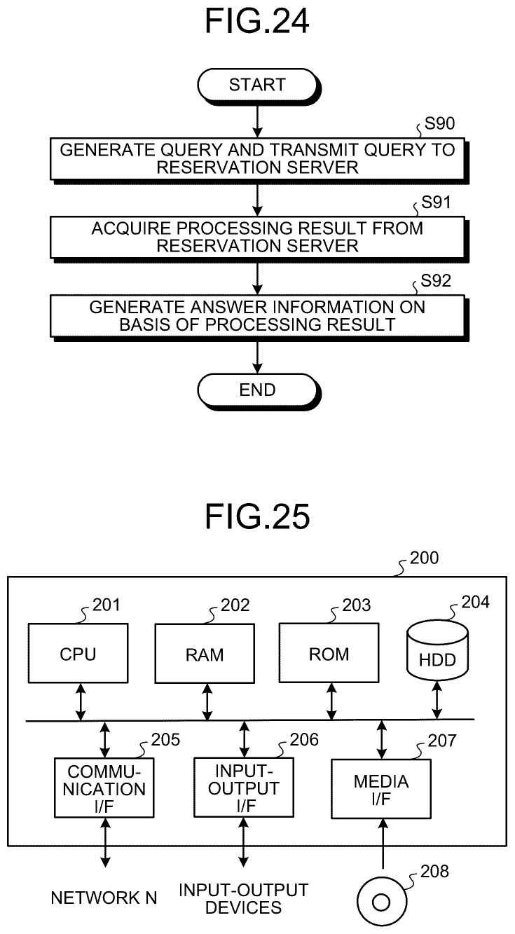

In a case where the processing unit 12 has determined that the intention type is not question (Step S55: No), the processing unit 12 determines that the intention type is reservation and performs reservation processing (Step S57). The reservation processing at Step S57 is processing at Steps S90 to S92 illustrated in FIG. 24 and will be described in detail later.

In a case where the processing at Step S54 is ended, in a case where the processing at Step S56 is ended, or in a case where the processing at Step S57 is ended, the processing unit 12 provides answer information to a user U (Step S58). The processing unit 12 then generates or updates the dialogue data 70 on the basis of a result of the processing at Step S54, a result of the processing at Step S56, or a result of the processing at Step S58 (Step S59).

In a case where processing at Step S59 is ended or in a case where the processing unit 12 determines that the user input information has not been received (Step S50: No), the processing unit 12 determines whether or not it has become time to end operation (Step S60). For example, the processing unit 12 determines that it has become time to end operation in a case where the power of the information processing apparatus 1 has been turned off.

In a case where the processing unit 12 determines that it has not become time to end operation (Step S60: No), the processing unit 12 advances the processing to Step S50, and in a case where the processing unit 12 determines that it has become time to end operation (Step S60: Yes), the processing unit 12 ends the processing illustrated in FIG. 21.

FIG. 22 is a flowchart illustrating an example of the search processing by the processing unit 12 of the information processing apparatus 1 according to the embodiment. As illustrated in FIG. 22, the processing unit 12 generates a search query on the basis of the output information from the generative AI and transmits the search query generated, to the search server 4 (Step S70).

Subsequently, the processing unit 12 acquires a search result corresponding to the search query, from the search server 4 (Step S71), generates answer information on the basis of the search result acquired (Step S72), and ends the processing illustrated in FIG. 22.

FIG. 23 is a flowchart illustrating an example of the question processing by the processing unit 12 of the information processing apparatus 1 according to the embodiment. As illustrated in FIG. 23, the processing unit 12 generates a search query on the basis of the output information from the generative AI and transmits the search query generated, to the search server 4 (Step S80).

Subsequently, the processing unit 12 acquires a search result corresponding to the search query from the search server 4 (Step S81). The processing unit 12 inputs information including the search result acquired at Step S81 and the user input information received at Step S50, to the generative AI (Step S82) and acquires output information from the generative AI (Step S83). The processing unit 12 then generates answer information on the basis of the output information acquired at Step S83 (Step S84) and ends the processing illustrated in FIG. 23.

FIG. 24 is a flowchart illustrating an example of the reservation processing by the processing unit 12 of the information processing apparatus 1 according to the embodiment. As illustrated in FIG. 24, the processing unit 12 generates a query on the basis of the output information from the generative AI and transmits the query generated, to the reservation server 5 (Step S90).

Subsequently, the processing unit 12 acquires a processing result corresponding to the query, from the reservation server 5 (Step S91), generates answer information on the basis of the processing result acquired (Step S92), and ends the processing illustrated in FIG. 24.

### 6. MODIFIED EXAMPLES

With respect to the above described examples, text generative AI has been described as an example of the generative AI, but the generative AI may be a multimodal generative AI.

Multimodal generative AI is, for example, generative AI that generates voice from text, generates text from voice, generates voice from voice, and generates text from text, and is, for example, GPT-4V, but is not limited to this example.

Furthermore, a user U may speak to a terminal device 2 and input, as input information, information on that speech to the terminal device 2, and the information on the speech input by the user U is transmitted as the input information to the information processing apparatus 1 from the terminal device 2.

In a case where information on voice that is speech by a user U is transmitted as input information from a terminal device 2, the information processing apparatus 1 may convert the information on the sound into text. The terminal device 2 may convert the information on the voice that is the speech by the user U, into text, and transmit, as input information, the text converted, from the terminal device 2 to the information processing apparatus 1.

### 7. HARDWARE CONFIGURATION

The above described information processing apparatus 1 according to the embodiment is implemented by a computer 200 configured as illustrated in FIG. 25, for example. FIG. 25 is a hardware configuration diagram illustrating an example of the computer 200 that implements functions of the information processing apparatus 1 according to the embodiment. The computer 200 has a CPU 201, a RAM 202, a read only memory (ROM) 203, a hard disk drive (HDD) 204, a communication interface (I/F) 205, an input-output interface (I/F) 206, and a media interface (I/F) 207.

The CPU 201 operates on the basis of programs stored in the ROM 203 or the HDD 204, and controls each unit. The ROM 203 stores, for example, a boot program executed by the CPU 201 when the computer 200 is booted, and a program dependent on hardware of the computer 200.

The HDD 204 stores, for example, programs executed by the CPU 201 and data used by the programs. The communication interface 205 receives data from another device via the network N (see FIG. 5) and transmits the data received, to the CPU 201, and transmits data generated by the CPU 201 to another device via the network N.

Via the input-output interface 206, the CPU 201 controls output devices, such as a display and a printer, and an input device, such as a keyboard or a mouse. The CPU 201 acquires data from the input device via the input-output interface 206. Furthermore, the CPU 201 outputs data generated, to the output devices via the input-output interface 206.

The media interface 207 reads a program or data stored in a recording medium 208 and provides the program or data read, to the CPU 201 via the RAM 202. The CPU 201 loads the program into the RAM 202 from the recording medium 208 via the media interface 207 and executes the program loaded. The recording medium 208 is, for example; an optical recording medium, such as a digital versatile disc (DVD) or a phase change rewritable disk (PD); a magneto-optical recording medium, such as a magneto-optical disk (MO); a tape medium; a magnetic recording medium; or a semiconductor memory.

For example, in a case where the computer 200 functions as the information processing apparatus 1 according to the embodiment, the CPU 201 of the computer 200 implements functions of the processing unit 12 by executing programs loaded into the RAM 202. Furthermore, data in the storage unit 11 are stored in the HDD 204. The CPU 201 of the computer 200 reads and executes these programs from the recording medium 208, but in another example, the CPU 201 may acquire these programs from another device via the network N.

### 8. OTHERS

Of the processing described above with respect the embodiment, all or part of any processing described as being performed automatically may be performed manually, or all or part of any processing described as being performed manually may be performed automatically by a publicly known method. In addition, the processing procedures, specific names, and information including various data and parameters described above and illustrated in the drawings may be modified in any way unless particularly stated otherwise. For example, the various kinds of information illustrated in the drawings are not limited to the illustrated information.

Furthermore, the elements of each apparatus/device in the drawings have been illustrated functionally and/or conceptually, and are not necessarily configured physically as illustrated in the drawings. That is, specific modes of separation and integration of each apparatus/device are not limited to those illustrated in the drawings, and all or part thereof may be configured to be functionally or physically separated or integrated in any units according to various loads and use situations.

For example, the above described information processing apparatus 1 may be implemented by a terminal device and a server computer or may be implemented by plural server computers. Furthermore, the configuration of the information processing apparatus 1 may thus be modified flexibly. For example, some of functions of the information processing apparatus 1 may be implemented by an external platform being called by means of an API and network computing.

Furthermore, the embodiment and modified examples described above may be combined, as appropriate, so long as no contradiction in the processing arises from the combination.

### 9. EFFECTS

As described above, the information processing apparatus 1 according to the embodiment includes the reception unit 30, the first acquisition unit 40, the second acquisition unit 41, the first generation unit 43, the provision unit 33, and the second generation unit 44. The reception unit 30 receives input information from a user U for a service for a specific purpose in a dialogue format using generative AI that generates output information corresponding to input information. The first acquisition unit 40 inputs information including the input information received by the reception unit 30, to the generative AI, and acquires output information corresponding to the input information from the generative AI. The second acquisition unit 41 acquires information corresponding to the output information acquired by the first acquisition unit 40. On the basis of the information acquired by the second acquisition unit 41 and corresponding to the output information, the first generation unit 43 generates answer information corresponding to the input information. The provision unit 33 provides the answer information generated by the first generation unit 43, to the user U. On the basis of the output information acquired by the first acquisition unit 40, the second generation unit 44 generates, as a history of dialogues with the user U, a user dialogue history to be input to the generative AI. The information processing apparatus 1 thereby enables reduction in the amount of information in the history of dialogues input to the generative AI in a service for exchange of messages in a dialogue format with the user U.

Furthermore, on the basis of the information corresponding to the output information acquired by the second acquisition unit 41, the second generation unit 44 generates, as a dialogue history of the generative AI, a generative AI dialogue history to be input to the generative AI. The information processing apparatus 1 thereby enables reduction in the amount of information in the history of dialogues input to the generative AI.

Furthermore, the first acquisition unit 40 inputs information including the input information 60 and intention definition information for extracting an intention type and an intention from the input information 60, to the generative AI, and acquires, as the output information, intention information including information indicating the intention type and information indicating the intention, from the generative AI; the first generation unit 43 generates the answer information on the basis of information corresponding to the information indicating the intention type and the information indicating the intention; and the second generation unit 44 generates the user dialogue history on the basis of the information indicating the intention type and the information indicating the intention. The information processing apparatus 1 thereby enables appropriate provision of the service for exchange of messages in the dialogue format with the user U.

Furthermore, the first acquisition unit 40 inputs information including, as the intention definition information, definition information defining each of plural functions, to the generative AI, and acquires, as the intention information, function specification information including information specifying a function used in generation of the answer information, the function being one of the plural functions, and information indicating arguments of the function, from the generative AI. The information processing apparatus 1 thereby enables appropriate provision of the service for exchange of messages in the dialogue format with the user U.

The plural functions include a function related to a search API, a function related to a question, and a function related to a reservation API. The information processing apparatus 1 thereby enables appropriate provision of the service for exchange of messages in the dialogue format with the user U.

The function related to the search API is a function that uses the search API, the function related to a question is a function that uses a function using the search API and a function using the generative AI, and the function related to the reservation API is a function that uses the reservation API. The information processing apparatus 1 thereby enables appropriate provision of the service for exchange of messages in the dialogue format with the user U.

The service for a specific purpose is a restaurant reservation service. The information processing apparatus 1 thereby enables appropriate provision of the service for exchange of messages in the dialogue format with the user U.

Furthermore, the second generation unit 44 generates the history of dialogues as structured data. The information processing apparatus 1 thereby enables appropriate provision of the service for exchange of messages in the dialogue format with the user U.

Furthermore, the first acquisition unit 40 extracts part of the history of dialogues, inputs information including the extracted information and the input information 60 received by the reception unit 30, to the generative AI, and acquires the output information corresponding to the input information from the generative AI. The information processing apparatus 1 thereby enables appropriate provision of the service for exchange of messages in the dialogue format with the user U.

The embodiment of the present application has been described above in detail on the basis of the drawings, but the embodiment is just an example, and the present invention can be implemented in other modes variously modified and improved on the basis of the mode described in the section, Detailed Description of the Preferred Embodiments, and knowledge of those skilled in the art.

Any “unit, section, or module” described above can be read as “means” or “circuit”, for example. For example, an acquisition unit can be read as an acquisition means or an acquisition circuit.

What is claimed is:

1. An information processing apparatus, comprising:
a reception unit that receives input information from a user for a service for a specific purpose in a dialogue format using generative AI that generates output information corresponding to input information;
a first acquisition unit that inputs information including the input information received by the reception unit, to the generative AI, and acquires output information corresponding to the input information, from the generative AI;
a second acquisition unit that acquires information corresponding to the output information acquired by the first acquisition unit;
a first generation unit that generates answer information corresponding to the input information, on the basis of the information acquired by the second acquisition unit, the information corresponding to the output information;
a provision unit that provides the answer information generated by the first generation unit, to the user; and
a second generation unit that generates, as a history of dialogues with the user, a user dialogue history to be input to the generative AI, on the basis of the output information acquired by the first acquisition unit.

2. The information processing apparatus according to claim 1, wherein the second generation unit generates, as a dialogue history of the generative AI, a generative AI dialogue history to be input to the generative AI, on the basis of the information acquired by the second acquisition unit, the information corresponding to the output information.

3. The information processing apparatus according to claim 1, wherein
the first acquisition unit inputs information including the input information and intention definition information for extracting an intention type and an intention from the input information, to the generative AI, and acquires, as the output information, intention information including information indicating the intention type and information indicating the intention, from the generative AI,
the first generation unit generates the answer information on the basis of information corresponding to both the information indicating the intention type and the information indicating the intention, and
the second generation unit generates the user dialogue history on the basis of the information indicating the intention type and the information indicating the intention.

4. The information processing apparatus according to claim 3, wherein the first acquisition unit inputs information including, as the intention definition information, definition information defining each of plural functions, to the generative AI, and acquires, as the intention information, function specification information from the generative AI, the function specification information including: information specifying a function used in generation of the answer information, the function being one of the plural functions; and information indicating arguments of the function.

5. The information processing apparatus according to claim 4, wherein the plural functions include a function related to a search, a function related to a question, and a function related to a reservation.

6. The information processing apparatus according to claim 5, wherein
the function related to a search is a function using a search API,
the function related to a question is a function using the search API and the generative AI, and
the function related to a reservation is a function using a reservation API.

7. The information processing apparatus according to claim 1, wherein the service for a specific purpose is a restaurant reservation service.

8. The information processing apparatus according to claim 1, wherein the second generation unit generates the history of dialogues as structured data.

9. The information processing apparatus according to claim 1, wherein the first acquisition unit extracts part of the history of dialogues, inputs information including the part extracted and the input information received by the reception unit, to the generative AI, and acquires output information corresponding to the input information, from the generative AI.

10. An information processing method executed by a computer and including:
a reception step of receiving input information from a user for a service for a specific purpose in a dialogue format using generative AI that generates output information corresponding to input information;
a first acquisition step of inputting information including the input information received through the reception step, to the generative AI, and acquiring output information corresponding to the input information, from the generative AI;
a second acquisition step of acquiring information corresponding to the output information acquired through the first acquisition step;
a first generation step of generating answer information corresponding to the input information, on the basis of the information acquired through the second acquisition step, the information corresponding to the output information;
a provision step of providing the answer information generated through the first generation step, to the user; and
a second generation step of generating, as a history of dialogues with the user, a user dialogue history to be input to the generative AI, on the basis of the output information acquired through the first acquisition step.

11. A non-transitory computer readable storage medium having stored an information processing program that causes a computer to execute:
a reception process of receiving input information from a user for a service for a specific purpose in a dialogue format using generative AI that generates output information corresponding to input information;
a first acquisition process of inputting information including the input information received through the reception process, to the generative AI, and acquiring output information corresponding to the input information, from the generative AI;
a second acquisition process of acquiring information corresponding to the output information acquired through the first acquisition process;
a first generation process of generating answer information corresponding to the input information, on the basis of the information acquired through the second acquisition process, the information corresponding to the output information;
a provision process of providing the answer information generated through the first generation process, to the user; and
a second generation process of generating, as a history of dialogues with the user, a user dialogue history to be input to the generative AI, on the basis of the output information acquired through the first acquisition process.
